(19) United States
(12) Patent Application Publication
(10) Pub. No.: US 2025/0381876 A1
(43) Pub. Date: Dec. 18, 2025

(54) SYSTEMS AND METHODS FOR FACILITATING CHARGING SESSIONS BETWEEN ELECTRIC VEHICLES AND CHARGERS

(71) Applicant: ChargeMate AI, Inc., Atherton, CA (US)

(72) Inventors: Bradford T. CRIST, Atherton, CA (US); Brian J. LANGE, Chicago, IL (US)

(73) Assignee: ChargeMate AI, Inc., Atherton, CA (US)

(21) Appl. No.: 19/237,944

(22) Filed: Jun. 13, 2025

Related U.S. Application Data
(60) Provisional application No. 63/660,012, filed on Jun. 14, 2024.

(51) Int. Cl. B60L 53/65; G06F 40/40; G06V 20/52

(52) U.S. Cl. CPC B60L 53/65; G06F 40/40; G06V 20/52; B60L 2240/62; B60L 2250/16

(57) ABSTRACT

A system for charging a target vehicle using a target charger is provided. The system comprises the target charger and one or more cameras positioned in a vicinity of the target charger. The system determines a hardware type and a software version of the target charger; obtains, from the one or more cameras, visual data corresponding to a physical environment of the target charger; identifies one or more features including the target vehicle, the target charger, and a user; and generates a system prompt for a large language model (LLM) based on the hardware type and/or the software version of the target charger, and/or the one or more features. The system transmits the system prompt to the LLM; receives an output from the LLM; and charges, or displays an instruction to the user to charge, the target vehicle using the target charger in accordance with the output from the LLM.

### CROSS-REFERENCE TO RELATED APPLICATIONS

This application claims the benefit of U.S. Provisional Patent Application No. 63/660,012, filed Jun. 14, 2024, the entire contents of which are incorporated herein by reference.

### FIELD

This invention relates generally to the field of charge station maintenance and usability and, more specifically, to new and useful systems and methods for facilitating charging sessions between electric vehicles and chargers in the field of charge station maintenance and usability.

### BACKGROUND

Drivers of electric vehicles seeking to charge may encounter significant variation across both charging station providers and vehicle designs, with differences in hardware and firmware configurations, software interfaces, and compatibility requirements. For example, on the charger side, designs may vary based on connector pin layouts, connection procedures, and/or user interface layouts. On the vehicle side, different manufacturers may locate charging ports in different areas of a vehicle, implement proprietary locking or access mechanisms, and/or limit the types of connectors that may interface to and/or charge a vehicle. For example, electric vehicle manufacturers may not produce or control electric vehicle charging hardware and charging providers may integrate multiple third-party components with differing software and hardware specifications. As a result, electric vehicle drivers may navigate inconsistent or unfamiliar charging processes. Relevant information about charger and/or vehicle configurations may not be readily accessible, making it difficult for users to find clear, context-specific guidance when charging issues arise.

### SUMMARY

Disclosed herein are systems and methods for facilitating electric vehicle charging sessions using visual context and large language model (LLM)-based reasoning. Disclosed systems may include one or more cameras positioned in the physical environment of a target charger, and a computing system configured to process visual data from the one or more cameras. Processing said visual data may enable identification of objects and/or user interactions with the target charger that may be relevant to an ongoing or an anticipated charging session. Detected features may include, for example, the presence of a target vehicle, a user interacting with the target charger, and/or physical elements of the target charger itself. An exemplary system may use object detection and classification models to extract information from the detected features, information which may be subsequently used to construct a system prompt for an LLM. For example, the system may apply optical character recognition to text visible in the visual data, such as license plates or charger messages. Information derived from the visual data may be combined with contextual data and/or inputs from the user to form a multi-source system prompt that may enable the LLM to reason about the current charging session state. By combining system-sourced information with user inputs, an exemplary system may enable generation of detailed system prompts even in cases in which the user lacks the technical knowledge to provide complete information about a charging issue.

In response to receiving a system prompt, the LLM may generate an output including one or more messages to be presented in a chat interface for user guidance. The output may include natural language responses configured to assist the user in completing or troubleshooting a charging session. For example, an output may instruct the user to reconnect a charging cable, scan a QR code, move to a different charger, and/or perform another action related to initiating and/or recovering a charging session. In some implementations, an output may request clarification from the user and/or confirm contextual data related to the charging session, such as by verifying the identity of the charger being used. By generating outputs based on real-time data and visual inputs, an exemplary system may enable provision of relevant, context-based support for charging station users.

In some implementations, disclosed systems may include a backend interface configured to present information to a support agent. This backend interface may present a user chat history, contextual data associated with the target charger and/or target vehicle, a search bar for querying documentation or internal tools, and/or a “recommended actions” section. The recommended actions may be generated by an LLM based on the evolving user chat history and/or charging session context, and may be presented as UI affordances configured for support agent interaction. These UI affordances may represent actions including, for example, sending a message to the user, initiating a reset of the target charger, and/or modifying a session variable such as the user's location and/or target vehicle type. Such a backend interface may thus enable support agents to provide context-aware assistance in resolving charging issues. Additionally or alternatively, the LLM output may include a control command to cause the target charger to charge the target vehicle and/or to modify an operational state of the target charger. For example, the control command may restore the target charger from an error state, switch the target charger from a standby mode to an active mode, and/or enable user interaction.

By integrating real-time visual analysis, structured prompt generation, and LLM-based decision-making, systems and methods disclosed herein may improve the functionality and responsiveness of charging support systems. Unlike known techniques that may entail a user searching for relevant troubleshooting steps in an FAQ document or attempting to manually diagnose a charging issue, exemplary systems and methods may enable the detection of user-charger interactions and/or charger status via visual data analysis, and the provision of this information for LLM-based reasoning. Generation of system prompts for LLM processing may be based on multiple sources including visual data, static and/or contextual datasets, and/or user inputs, without relying on the user for technical details such as the target charger model and/or fault status, for example. Responsive and context-sensitive support that may be provided by such systems and methods may in turn reduce the frequency of failed charging sessions and/or improve user guidance in unfamiliar charging environments.

In some embodiments, a system for charging a target vehicle using a target charger is provided, the system comprising: the target charger, wherein the target charger is configured to charge the target vehicle; one or more cameras positioned in a vicinity of the target charger; and a computing system comprising a memory and one or more processors, wherein the memory stores instructions that when executed by the one or more processors, cause the system to: determine a hardware type of the target charger and a software version of the target charger; obtain, from the one or more cameras positioned in the vicinity of the target charger, visual data corresponding to a physical environment of the target charger; identify, based on the visual data, one or more features associated with a charging session, wherein the one or more features are selected from a group consisting of: the target vehicle, the target charger, and a user; generate a system prompt for a large language model (LLM) based on at least one parameter selected from a group consisting of: the hardware type of the target charger, the software version of the target charger, and the one or more features associated with the charging session; transmit the system prompt to the LLM; receive an output from the LLM; and charge the target vehicle using the target charger in accordance with the output from the LLM or display an instruction to the user to charge the target vehicle using the target charger in accordance with the output from the LLM.

In some embodiments, both the hardware type of the target charger and the software version of the target charger are determined based on a geographic location of a user device or a geographic location of the target vehicle. In some embodiments, both the hardware type of the target charger and the software version of the target charger are based on information provided by the user or on information transmitted from the target charger. In some embodiments, the system prompt is generated based at least in part on historical fault data or usage patterns associated with the target charger. In some embodiments, the instructions further cause the system to receive vehicle status data from the target vehicle, the vehicle status data comprising one or more vehicle statuses associated with the charging session. In some embodiments, the instructions further cause the system to determine, based on information provided by the user or on information transmitted from the target charger, a make of the target vehicle and a model of the target vehicle. In some embodiments, generating the system prompt for the LLM is further based on at least one parameter selected from a group consisting of: the make of the target vehicle, the model of the target vehicle, and at least one of the one or more vehicle statuses. In some embodiments, the instructions further cause the system to receive charger status data from the target charger, the charger status data comprising one or more charger statuses associated with the charging session, wherein generating the system prompt for the LLM is further based on at least one of the one or more charger statuses. In some embodiments, the visual data is further obtained from a device of the user comprising a camera. In some embodiments, the one or more features associated with the charging session comprise the target vehicle, the target charger, and the user. In some embodiments, the one or more features associated with the charging session comprise a user interaction with the target charger. In some embodiments, the one or more features associated with the charging session comprise at least one attribute of the target vehicle selected from a group consisting of: a make, a model, and a year of manufacture. In some embodiments, the one or more features associated with the charging session comprise alphanumeric content corresponding to a display of the target charger or a license plate of the target vehicle. In some embodiments, the LLM is a multimodal model configured to process visual and textual inputs, and wherein the system prompt comprises at least a portion of the visual data. In some embodiments, generating the system prompt for the LLM is based on a user query received from a front-end module installed on a device of the user. In some embodiments, charging the target vehicle using the target charger in accordance with the output from the LLM comprises at least one action selected from a group consisting of: transmitting a control command to reset the target charger, modifying a power delivery setting of the target charger, initiating a diagnostic operation on the target charger, and reporting a fault condition of the target charger. In some embodiments, displaying an instruction to the user to charge the target vehicle comprises displaying the instruction to the user on a device of the user or a display of the target charger. In some embodiments, displaying the instruction to the user comprises: generating an indication corresponding to a component of the target charger or a component of the target vehicle; and instructing the user to perform a physical action with respect to the component of the target charger or the component of the target vehicle. In some embodiments, the indication is based on the one or more features identified based on the visual data corresponding to the physical environment of the target charger. In some embodiments, displaying the instruction to the user comprises displaying a sequence of steps configured to guide the user in resolving a charging-related issue. In some embodiments, the instructions further cause the system to monitor, based on the visual data, user activity indicative of progress toward completing one or more of the sequence of steps. In some embodiments, displaying a step of the sequence of steps is based on a determination that the user completed a prior step of the sequence of steps. In some embodiments, the instructions further cause the system to display, in response to receiving the output from the LLM, one or more affordances on a user interface, the one or more affordances corresponding to transmitting a communication to the user or transmitting a command to modify an operational state of the target charger. In some embodiments, the instructions further cause the system to: monitor the visual data corresponding to the physical environment of the target charger; detect an event associated with the target charger; and in response to detecting the event, display a notification on a user interface. In some embodiments, the event is indicative of abnormal use of the target charger or a fault condition of the target charger. In some embodiments, the instructions further cause the system to, in response to receiving an output from the LLM comprising a function call to the target charger, transmit the function call to the target charger, the function call effective to modify operation of the target charger. In some embodiments, the instructions further cause the system to, in response to receiving an output from the LLM comprising a function call to a charging network of the target charger, transmit the function call to the charging network, the function call effective to report damage to the target charger, a software issue affecting the target charger, or both. In some embodiments, the instructions further cause the system to, in response to receiving an output from the LLM comprising a function call to a user device, transmit the function call to the user device, the function call effective to activate a camera on the user device and prompt the user to capture visual data depicting the target vehicle or the target charger.

A method for charging a target vehicle using a target charger, the method comprising: determining a hardware type of the target charger and a software version of the target charger; obtaining, from one or more cameras positioned in a vicinity of the target charger, visual data corresponding to a physical environment of the target charger; identifying, based on the visual data, one or more features associated with a charging session, wherein the one or more features are selected from a group consisting of: the target vehicle, the target charger, and a user; generating a system prompt for a large language model (LLM) based on at least one parameter selected from a group consisting of: the hardware type of the target charger, the software version of the target charger, and the one or more features associated with the charging session; transmitting the system prompt to the LLM; receiving an output from the LLM; and charging the target vehicle using the target charger in accordance with the output from the LLM or displaying an instruction to the user to charge the target vehicle using the target charger in accordance with the output from the LLM.

A non-transitory computer readable storage medium storing instructions for charging a target vehicle using a target charger, wherein the instructions, when executed by one or more processors of an electronic device, cause the device to: determine a hardware type of the target charger and a software version of the target charger; obtain, from the one or more cameras positioned in the vicinity of the target charger, visual data corresponding to a physical environment of the target charger; identify, based on the visual data, one or more features associated with a charging session, wherein the one or more features are selected from a group consisting of: the target vehicle, the target charger, and a user; generate a system prompt for a large language model (LLM) based on at least one parameter selected from a group consisting of: the hardware type of the target charger, the software version of the target charger, and the one or more features associated with the charging session; transmit the system prompt to the LLM; receive an output from the LLM; and charge the target vehicle using the target charger in accordance with the output from the LLM or display an instruction to the user to charge the target vehicle using the target charger in accordance with the output from the LLM.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1A depicts a system for charging a target vehicle using a target charger, according to some embodiments.

FIG. 1B depicts a process for charging a target vehicle using a target charger, according to some embodiments.

FIG. 1C depicts a process for charging a target vehicle using a target charger, according to some embodiments.

FIG. 2A depicts a process for displaying affordances associated with charging a target vehicle using a target charger, according to some embodiments.

FIG. 2B depicts a backend user interface associated with charging a target vehicle using a target charger, according to some embodiments.

FIG. 3 depicts a flowchart representation of one variation of a method for facilitating charging sessions between electric vehicles and chargers, according to some embodiments.

FIG. 4A depicts a schematic representation of one variation of a system configured to execute a hardware-integrated method for facilitating charging sessions between electric vehicles and chargers, according to some embodiments.

FIG. 4B depicts a schematic representation of one variation of a system configured to execute a hardware-integrated method for facilitating charging sessions between electric vehicles and chargers, according to some embodiments.

FIG. 4C depicts a schematic representation of one variation of a system configured to execute a hardware-integrated method for facilitating charging sessions between electric vehicles and chargers, according to some embodiments.

FIG. 4D depicts a schematic representation of one variation of a system configured to execute a hardware-integrated method for facilitating charging sessions between electric vehicles and chargers, according to some embodiments.

FIG. 5A depicts a chat user interface associated with charging a target vehicle using a target charger, according to some embodiments.

FIG. 5B depicts a chat user interface associated with charging a target vehicle using a target charger, according to some embodiments.

FIG. 6A depicts a chat user interface associated with charging a target vehicle using a target charger, according to some embodiments.

FIG. 6B depicts a chat user interface associated with charging a target vehicle using a target charger, according to some embodiments.

FIG. 7A depicts a chat user interface associated with charging a target vehicle using a target charger, according to some embodiments.

FIG. 7B depicts a chat user interface associated with charging a target vehicle using a target charger, according to some embodiments.

FIG. 7C depicts a chat user interface associated with charging a target vehicle using a target charger, according to some embodiments.

FIG. 7D depicts a chat user interface associated with charging a target vehicle using a target charger, according to some embodiments.

FIG. 8 depicts an exemplary computing system, according to some embodiments.

### DETAILED DESCRIPTION

Disclosed herein are systems and methods for charging an electric vehicle using visual data captured by one or more cameras, structured prompt generation techniques, and LLM-based guidance. Unlike known charging support systems that may rely on static troubleshooting processes, disclosed systems may observe user interaction with a target charger to identify relevant features that inform user guidance and control actions. An exemplary system may receive data from one or more cameras positioned in the vicinity of the target charger and use that visual data to detect objects and/or interpret user behavior. For example, visual data may be processed using optical character recognition to detect textual features and/or using object detection models to identify charger hardware, vehicle make, vehicle model, and/or user-charger interactions. Features detected in the visual data may be combined with contextual data and/or user inputs to generate a complete system prompt. This system prompt may then be processed by an LLM, which may generate an output used to initiate charging of a target vehicle and/or display an instruction guiding the user to complete the charging process.

An exemplary system may receive inputs from the one or more cameras, target charger, and/or target vehicle to identify visual, environmental, and/or operational features relevant to a charging issue faced by a user. These features may include, for example, the presence and orientation of a target vehicle, the state of the charging connector and/or charging port, detected user interactions, and/or the operational status of the target charger and/or target vehicle. The system may also consider contextual data such as vehicle make and/or model, charger software version, charger configuration, and/or historical fault records associated with the target charger. In some implementations, detected visual features and/or contextual data may be converted into natural language descriptions and optionally combined with inputs from the user to form a complete system prompt for an LLM to interpret. Outputs received from the LLM may include instructions for the user, clarification questions, session parameter updates, and/or control commands to initiate or modify target charger operation.

These LLM outputs may be displayed on one or more user-facing or backend interfaces. For example, LLM outputs may be displayed on a chat or voice interface of a front-end module executing on a user device, the target charger, and/or the target vehicle. In some implementations, the chat interface may instruct the user to capture and submit a photo or video using the user device, for example to visually confirm the presence of the target vehicle, the physical state of the target charger, or a visible fault indicator. Such a chat interface may allow the user to engage with the system through natural language, button-based response options, and/or multimedia input such as a captured photo or video. In some implementations, the system may prompt the user to confirm vehicle characteristics, describe a charging issue, and/or complete a recommended action, for example reconnecting the charging cable and/or verifying that the target vehicle is unlocked. Additionally or alternatively, LLM outputs and/or evolving contextual data associated with a charging session may be displayed to a support agent on a backend interface. Such contextual data may include an updated chat transcript, status data associated with the target charger and/or target vehicle, visual data captured by the one or more cameras, and/or recommended actions to resolve an identified charging issue. These recommended actions may be generated by the LLM and presented as selectable UI affordances to streamline issue resolution. Outputs from the LLM may additionally or alternatively include structured function calls such as those for resetting the charger, activating a user's mobile camera, reporting target charger damage, and/or retrieving historical charging session logs.

Systems and methods disclosed herein may provide advantages over known electric vehicle charging support systems by enabling rapid resolution of issues without a user searching for relevant troubleshooting steps or manually diagnosing a charging issue. Unlike traditional LLM prompts that may rely solely on user input, disclosed systems may generate multi-source system prompts using a combination of visual data, contextual data, and/or user inputs. Disclosed systems and methods may automatically identify the charging issue, generate a context-specific prompt to enable LLM-driven reasoning, and/or provide a tailored solution to the charging issue. For example, if a user indicates that “the charger is not working,” the system may extract relevant details from visual data, log data, and/or historical patterns to construct a complete system prompt without requesting additional information from the user.

An exemplary system's ability to interpret multimodal inputs, issue control commands, and provide tailored responses based on contextual data associated with the charging session may enable broad compatibility across variations in charger type, vehicle type, and user behavior. In some implementations, the user's role may be limited to minimal interactions, such as pointing a device camera and/or selecting a vehicle type, with the system generating a detailed system prompt for LLM processing. This approach may address limitations of known charging support systems that may fail to solve a charging issue if a user is unable to describe the issue precisely or navigate a static troubleshooting guide. Systems and methods disclosed herein may thus improve charging session success rates, reduce support latency, and/or enable automated control of charger behavior based on the specific conditions of each charging environment.

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples. In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Generally, the term “charger,” as utilized herein, refers to an individual charging device that can be engaged in a charging session with a single electric vehicle. The term “charging station” may be used interchangeably with “charger” herein. The term “charging site” refers to a location where one or more chargers are installed, which may share a single electrical circuit and may be controlled together based on grid conditions, current usage of one or more chargers, and/or other conditions. The term “charging session,” as utilized herein, refers to an attempt (successful or unsuccessful) to charge an electric vehicle via a charger. The term “charging network operator” refers to an organization responsible for the maintenance and/or operation of a network of chargers and/or charging sites.

Generally, the term “large-language model” (“LLM”), as utilized herein, refers to any model capable of receiving linguistic input and responding with a linguistic output. For example, the term “LLM” can include transformer-based models (e.g., generative pre-trained transformer models or GPT models, bidirectional encoder representations from transformers or BERT models, encoder-decoder models, autoregressive models, and/or denoising autoencoder models). Additionally, the term “LLM” can refer to models capable of multimodal input and/or multimodal output in the form of text, audio, images, and/or video.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

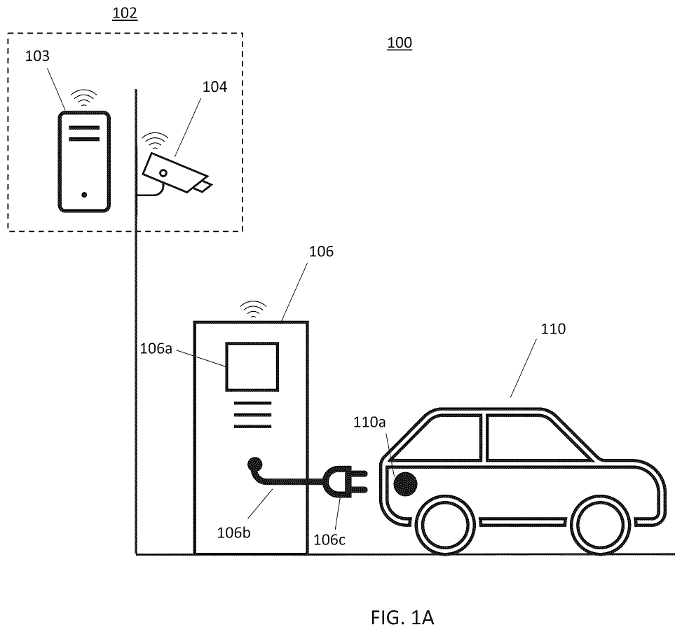

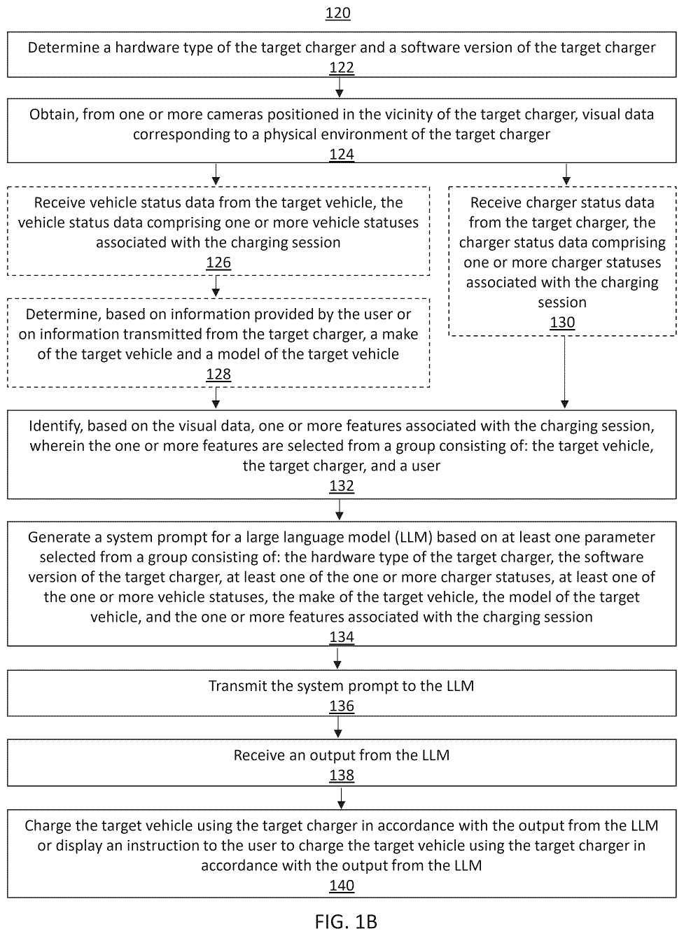

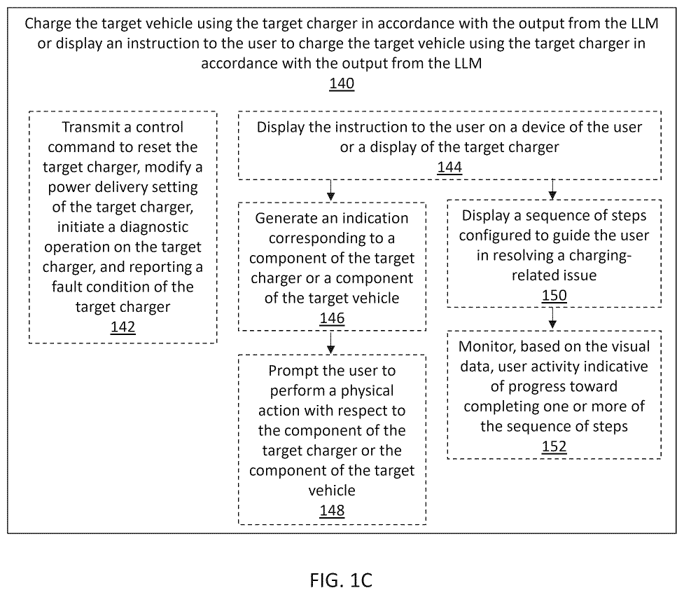

FIG. 1A depicts a view 100 including exemplary system 102 for charging a target vehicle 110 using a target charger 106 configured to charge the target vehicle. As shown, view 100 includes system 102 which may in turn include a computing system 103 and one or more cameras, such as camera 104, positioned in a vicinity of the target charger; a target charger 106 which may include a user interface 106a, a charging cable 106b, and a charging connector 106c; and a target vehicle 110 which may include a charging port 110a.

Computing system 103 may include a local or remote computing platform configured to coordinate data acquisition, machine learning model interaction, and/or charging session control. In some implementations, computing system 103 may be housed in a backend server infrastructure operated by a charging network provider. In other implementations, computing system 103 may include edge computing resources deployed at or near target charger 106, such as a computing module integrated into target charger 106 and/or nearby infrastructure.

Computing system 103 may include one or more processors, memory, and networking hardware configured to execute software modules for visual processing, LLM prompt generation, and/or charger control. In some implementations, computing system 103 may run software that decides whether to process inference tasks locally or send them to cloud-based machine learning models. Computing system 103 may be communicatively coupled to target charger 106, a device of the user (e.g., a smartphone or vehicle interface app), and/or target vehicle 110. This connection may enable computing system 103 to receive charger status data from target charger 106, user input and/or visual data from the device of the user, and/or vehicle status data from target vehicle 110.

Camera 104 may include one or more visual sensors positioned to capture a view of the physical environment surrounding target charger 106. In some implementations, camera 104 may be pole-mounted, embedded in target charger 106, or integrated into overhead infrastructure at the charging site. Camera 104 may capture visual data such as one or more images and/or video data. For example, camera 104 may capture individual images, video feeds, and/or sequences of frames. This data may be analyzed to detect features such as the presence of a user and/or target vehicle 110, the user's interaction with target charger 106, and/or physical obstructions. In some implementations, camera 104 may be part of a stereo or depth camera setup, and/or may be capable of operating under low-light conditions to support continuous monitoring of the physical environment of target charger 106.

Target charger 106 may include electric vehicle supply equipment capable of initiating and managing a charging session with a compatible vehicle. For example, target charger 106 may be a high-power or standard electric vehicle charger and may be used in public and/or semi-public settings. For example, target charger 106 may be associated with a fleet of vehicles. User interface 106a may include a touchscreen display, a keypad, one or more LEDs, and/or a QR code label or RFID sensor used for user identification and/or session initiation.

Charging cable 106b and charging connector 106c may vary based on the standard and/or type of target charger 106 and/or on local infrastructure requirements. Charging cable 106b may be fixed to target charger 106 or may be part of a separate cable management system. Charging connector 106c may be configured for one or more charging standards including, for example, CCS, CHAdeMO, NACS, or proprietary formats. For example, the configuration of charging connector 106c may vary based on vehicle charging port standards and/or local regulations. In some implementations, charging connector 106c may include sensors that detect vehicle charging port status, temperature, and/or tension within charging cable 106b, providing additional data to system 102.

Target vehicle 110 may include an electric vehicle that may or may not be compatible with target charger 106. Compatibility may depend on factors such as the charging standard supported by target vehicle 110 (e.g., CCS, CHAdeMO, and/or NACS) and the power delivery capabilities of target charger 106. The location and type of a charging port 110a may vary depending on the make and model of target vehicle 110. For example, charging port 110a may be positioned at the front, rear, or side of target vehicle 110, and may support AC charging, DC fast charging, or both. In some implementations, charging port 110a may include features such as a physical cover, indicator lights, and/or a locking mechanism. In some implementations, charging port 110a may be located within a recessed portion of vehicle 110 and/or may be integrated into a front grille, rear quarter panel, or another accessible portion of vehicle 110.

In some implementations, vehicle 110 may transmit vehicle-specific status data such as battery charge state and/or charging port status to system 102, directly and/or via charger 106. In some implementations, information about vehicle make, model, and/or configuration may be inferred based on visual data acquired by camera 104 and/or processed by computing system 103. System 102 may be configured to function with or without direct communication from target vehicle 110 and/or target charger 106. For example, certain vehicles may support exchange of information with target charger 106 such as battery charge state, charging preferences, and/or vehicle identification. Other vehicles may initiate charging with minimal vehicle-to-charger data exchange, instead relying more heavily on user input to complete the charging process for example.

In some implementations, the components of system 102, including computing system 103, camera 104, target charger 106, target vehicle 110, and/or one or more user devices, may be communicatively coupled using wired and/or wireless connections. Wireless connectivity may include Wi-Fi, cellular, and/or Bluetooth protocols. For example, target charger 106 may be connected to computing system 103 via a wired network link (e.g., Ethernet) or a wireless connection (e.g., Wi-Fi or cellular), enabling exchange of data including transmission of target charger status data to computing device 103. For example, charging connector 106b and charging port 110a may form a data interface via a wired connection, allowing target vehicle 110 to communicate vehicle status data to target charger 106 and onward to computing system 103. Additionally or alternatively, vehicle 110 may communicate vehicle status data to computing system 103 directly over a wireless connection (e.g., Wi-Fi or cellular). Camera 104 may be connected to computing system 103 using Ethernet, USB, Bluetooth, and/or a local wireless link. User devices, such as smartphones running a front-end module and/or application, may interface with computing system 103 over a cloud connection and/or via a Bluetooth or local wireless access point. Such user devices may enable the provision of text and/or voice inputs to system 102 as part of process 120 as described in further detail below.

FIG. 1B depicts an exemplary process 120 for charging a target vehicle using a target charger based at least in part on visual data corresponding to a physical environment of the target charger. Process 120 may involve data acquisition from multiple modalities, integration of the data into a system prompt for an LLM, and execution of actions and/or production of guidance based on the LLM output. In some implementations, process 120 may be executed by system 102 which may include (1) computing system 103 communicatively coupled to target charger 106, a device of the user, and/or target vehicle 110, and (2) one or more cameras such as camera 104 positioned to monitor the physical environment of target charger 106.

In some implementations, process 120 may be initiated by a front-end module. For example, the front-end module may include an application executing on a user device, such as a smartphone, that may allow the user to initiate a support request, enter a query, and/or capture and transmit visual data. In another example, the front-end module may execute on the target charger itself, for example it may be displayed on the user interface of the target charger. In yet another example, the front-end module may execute on the target vehicle's onboard user interface, for example it may be displayed on the central console of the target vehicle.

The front-end module may include a mobile application or web-based interface that allows the user to interact with system 102 before or during a charging session. For example, as described in further detail below, the user may provide a question or issue using the front-end module which may be received by system 102 as text or voice input. Similarly, system 102 may generate a text or voice output in response to a text or voice input from the user. The front-end module may additionally or alternatively support capture of visual data via a camera of the user device, target charger, and/or target vehicle. For example, using the front-end module, the user may scan a QR code on the target charger and/or record a video of the setup of the target charger. Inputs received via the front-end module may be used to trigger contextual data retrieval and/or initiate one or more steps of process 120, such as visual data capture and/or prompt generation, as described in further detail below.

At step 122 of process 120, an exemplary system such as system 102 may determine a hardware type of the target charger and a software version of the target charger. This determination may be based on one or more identifiers provided by the target charger (e.g., a charger ID transmitted by the target charger to system 102) and/or retrieved based on a user input. For example, both the hardware type of the target charger and the software version of the target charger may be based on information provided by the user or on information transmitted from the target charger. Such a user input may include, for example, visual data in the form of an image of the target charger captured by a device of the user, a scan of a QR code by the user, and/or a selection from a list of nearby chargers presented in a front-end module on the device of the user. In some implementations, system 102 may query a database to retrieve known hardware specification and/or firmware version data associated with the charger ID.

Additionally or alternatively, system 102 may determine the hardware type and software version of the target charger based on a geographic location of the user device and/or a geographic location of the target vehicle, for example by matching the location to a known charger installation site in a backend database. The geographic location of the user device and/or the target vehicle may be determined based on, for example, GPS data provided by the user device and/or target vehicle, a network-based location service, and/or a scan of a QR code associated with the charging site.

Step 122 may thus be carried out in connection with receiving identifying data via a front-end module and/or a backend status feed. For example, system 102 may receive charger identification data including a hardware identifier and/or a software version from a user device and/or from a backend system communicatively coupled to the target charger. For example, such a backend system may be a charging network operator's server that maintains configuration records and/or operational status for deployed chargers. The determined hardware type and/or software version may be used downstream in process 120 for example by filtering system prompt content to match charger capabilities and/or known error patterns.

At step 124, computing system 103 of system 102 may obtain visual data corresponding to a physical environment of the target charger from one or more cameras, such as camera 104 of system 102, positioned in the vicinity of the target charger. As described above, the one or more cameras may be positioned in the vicinity of the target charger. For example, the one or more cameras may be fixed to a structure in the vicinity of the target charger and/or may be integrated into the target charger itself. The visual data may include video feeds, still images, and/or a sequence of image frames sampled over time. Additionally or alternatively, the visual data may be obtained from a device of the user including a camera. For example, the user may capture an image or video of the target charger or target vehicle using a smartphone, tablet, or other camera-equipped device.

Step 124 may thus enable system 102 to observe physical activity near the target charger, such as vehicle positioning, user presence, charging connector and port interaction, and/or screen visibility. In implementations where the visual data is collected by infrastructure cameras, system 102 may associate each camera feed with spatial metadata indicating which charger stall, charger, and/or zone is captured by which camera feed, enabling system 102 to generate a correlation between visual data and charging hardware.

Following step 124, process 120 may optionally proceed through either or both of steps 126 and 130. At step 126, system 102 may receive vehicle status data directly from the target vehicle. The vehicle status data may include one or more vehicle statuses associated with the charging session. For example, vehicle status data may include values corresponding to charge state, charging port connection status, vehicle identifier, and/or diagnostic messages. Vehicle status data may be updated periodically or streamed in real time (e.g., forming a vehicle stream). This vehicle status data may be transmitted to system 102 from the target vehicle using a wireless communication interface and/or via a physical communication link established via the target charger. For example, wireless communication may be performed using Bluetooth, Wi-Fi, and/or cellular connectivity. For example, system 102 may determine, based on information provided by the user or on information transmitted from the target charger, a make of the target vehicle and a model of the target vehicle.

For example, a physical communication link may enable data to be exchanged through the same charging connector used for power delivery. For example, the target vehicle and target charger may communicate directly via the charging connector and charging port to share information such as vehicle identifier, charging connector and/or charging port status, charge state, and/or other vehicle-reported values that may be used to generate a system prompt for input to an LLM. This vehicle status data may be transmitted as discrete updates at regular intervals or as part of a real-time data stream. Such vehicle status data transmissions may enable system 102 to maintain an up-to-date view of charging session progress, detect changes in vehicle state, and/or trigger further processing.

Following step 126, process 120 may proceed to step 128, at which system 102 may determine a make and model of the target vehicle. This determination may be based on a user input specifying the make and/or model of the target vehicle, and/or on a vehicle ID (such as a VIN or license plate number). The vehicle ID may be extracted from visual data captured using the one or more cameras, provided as a user input, and/or received from the target vehicle itself. In some implementations, the make and/or model of the target vehicle may be inferred based on visual recognition of the vehicle in the visual data using a trained or zero-shot vehicle classification model. For example, system 102 may identify distinguishing visual features such as the shape of the headlights, grille, and/or manufacturer badge, and match them against a database of known vehicle designs. For example, system 102 may use zero-shot learning to associate the overall vehicle silhouette and proportions with likely vehicle makes and/or models, even if the exact vehicle make and/or model was not part of the dataset used to train the classification model.

In parallel to or in place of vehicle status data processing, step 130 may involve system 102 receiving charger status data from the target charger. Such data may include current output, fault conditions, idle or active states, session status, and/or historical error logs. For example, target charger status data may include one or more charger statuses associated with the charging session. This charger status data may be updated periodically or streamed in real time (e.g., forming a charger stream). In some implementations, the target charger may transmit to system 102 updated charger status data at a regular interval (e.g., every few seconds). In other implementations, the target charger may continuously stream charger status data, pushing updates to system 102 as events occur.

Charger status data such as charger operational state, error code presence, and/or power delivery status may also be used to detect prompt conditions (e.g., a failed session attempt) that trigger further analysis by system 102. A prompt condition may be detected, for example, when the target charger enters a fault state, when power delivery is unexpectedly interrupted, and/or when system 102 receives an error indicating an unsuccessful connection or authorization attempt. In response, system 102 may collect additional contextual data and generate a system prompt describing the issue, which may then be processed by an LLM to recommend corrective actions and/or classify the failure.

At step 132, system 102 may identify, based on the visual data obtained in step 124, one or more features associated with the charging session. The one or more features may include, for example, the presence and/or orientation of the target vehicle, whether a user is physically interacting with the target charger, and/or whether the target charger appears to be obstructed and/or damaged. For example, the identified one or more features associated with the charging session may include the target vehicle, the target charger, the user, a user interaction with the target charger, at least one attribute of the target vehicle such as a make, a model, and/or a year of manufacture of the target vehicle, and/or alphanumeric content corresponding to a display of the target charger or a license plate of the target vehicle. Identification of the one or more features may be performed using trained or zero-shot object detection models. For example, system 102 may use a pre-trained object detection model to locate and classify specific components including, for example, a charging port of the target vehicle, a charging connector of the target charger, and/or a status light of the target charger, within the visual data. The identified features may be associated with metadata including, for example, a bounding box, a pixel-level mask, and/or a descriptive label to provide additional context. In some implementations, system 102 may determine, based on the visual data, whether a user is physically interacting with the target charger and generate a corresponding description of the interaction. System 102 may additionally or alternatively determine, based on the visual data, whether the target charger is obstructed or inaccessible and generate a description of the obstruction or inaccessibility.

Additional features that may be identified by system 102 in the visual data may include the positioning and/or routing of the charging cable of the target charger, for example whether the charging cable appears overstretched or improperly stored. System 102 may additionally or alternatively identify in the visual data features corresponding to the environmental context including, for example, lighting conditions and/or weather-related visibility issues. In some implementations, system 102 may identify whether the target vehicle is correctly positioned relative to the target charger. In some implementations, system 102 may identify the presence of foreign objects including, for example, other vehicles, debris, and/or other pedestrians in the vicinity of the target charger. As described below, identified features may be used to generate a system prompt for input to an LLM and/or to trigger specific actions, such as the display of alerts and/or user action recommendations.

In some implementations, an environmental module may be responsible for evaluating external conditions surrounding the target charger and/or target vehicle. The environmental module may be stored in memory and executable by one or more processors of computing system 103. The environmental module may process inputs such as lighting, weather, and/or physical obstructions detected in the visual data. Additionally or alternatively, the environmental module may retrieve data from external sources such as weather APIs and/or sensors associated with the charging station (e.g., temperature, humidity, and/or precipitation sensors). The environmental module may determine whether these factors are likely to impact charging behavior or user interaction. For example, extreme heat or cold may reduce charging efficiency or trigger safety-related limits associated with a target vehicle's battery or a target charger's control circuit. The environmental module may flag certain conditions, such as poor visibility or foreign object presence, to be included in downstream system prompt generation.

At step 134 of process 120, system 102 may generate a system prompt for an LLM based on one or more of the following parameters: hardware type of the target charger, software version of the target charger, target charger status data, target vehicle status data, target vehicle make and/or model, and/or one or more of the features associated with the charging session identified in the visual data as described above. For example, system 102 may generate a system prompt based on at least one parameter selected from: the make of the target vehicle, the model of the target vehicle, at least one of the one or more vehicle statuses, and/or at least one of the one or more charger statuses. In some implementations, an exemplary system prompt may be generated based at least in part on historical fault data or usage patterns associated with the target charger. In some implementations, an exemplary system prompt may be based on a user query received from a front-end module installed on a device of the user. In some implementations, additional contextual parameters may be incorporated into the system prompt, such as the temperature of the target vehicle and/or target charger, the local time and day of week, and/or the real-time pricing conditions applicable to the charging session. System 102 may also consider the operational status of site-level energy management systems (e.g., available site power and/or battery storage levels), electrical grid conditions (e.g., load limits and/or emergency events), and/or the reported status of cloud services or payment processing systems. Network connectivity status, such as outages or degraded cellular or ISP performance, may also be included to help diagnose failed charger connections. In some implementations, system 102 may also retrieve or receive promotional offers from nearby businesses, such as discounts available to charging users (e.g., a discount on coffee drinks at a café in the building hosting the charger). Such offers may vary based on promotion campaign parameters, business budgets, time of day, and/or day of week.

In some implementations, the system prompt may further incorporate information related to site-level vehicle traffic and/or driver behavior. For example, system 102 may detect a queue of electric vehicles waiting to charge based on security camera footage or external sensors, and may pass an indication of current charger congestion to the LLM. In turn, the LLM may generate guidance to help reduce station-level delays, such as recommending that users limit charging to 80-85% battery capacity to improve turnover. System 102 may also receive operational status data from a charge point management system or cloud-based charging network platform, such as reports of station outages or faults. This data may allow the LLM to suggest corrective actions (e.g., rebooting a charger, messaging a technician, and/or switching a user to another charger). In some implementations, if system 102 has access to driver-specific trip context (e.g., estimated destination, current range of the target vehicle, and/or trip type), system 102 may provide this context to the LLM to generate modified guidance. For example, a long-distance driver may be encouraged to charge to full, whereas a local commuter or ride-share operator may be prompted to stop at 80-85% battery capacity to reduce wait times for others and/or to enable charging throttling to extend charger availability.

In some implementations, system 102 may further incorporate driver-specific characteristics into the system prompt to tailor LLM outputs. For example, system 102 may infer user characteristics from visual data (e.g., age indicators or observed behavior) and/or retrieve such characteristics from stored user account information maintained by the charging network. These characteristics may include whether the user is a first-time visitor to the charging site, a frequent user, and/or an account holder with known preferences and/or support history. Based on this context, the system prompt may be adapted to reflect a preferred interaction style. For example, system 102 may configure the LLM to provide simplified, step-by-step instructions to an inexperienced or infrequent user. For example, system 102 may configure the LLM to streamline guidance and/or limit provision of basic instructions for a repeat user familiar with the charging process. Such user-specific customization may enhance system responsiveness and improve the overall user experience by adapting both content and tone of the LLM-generated output to a user's likely level of familiarity and/or comfort with the charging environment.

In some implementations, these contextual parameters may be pre-fetched or pre-called by system 102 and included in all prompts by default, ensuring consistent LLM input coverage even when user or visual data is limited. In some implementations, the system prompt may be created using a predefined template or a prompt generation model. For example, the system prompt may include descriptive natural language derived from features identified in the visual data (e.g., “A user is attempting to plug in a cable at charger 4 of station 53. The screen appears blank.”).

The system prompt may be tailored based on the type and/or severity of the detected features and/or issue a user is experiencing. For example, if the visual data indicates that a user is interacting with the target charger but the screen of the target charger is unresponsive, the system prompt may emphasize potential display or input faults. For example, if no user interaction is detected and the target vehicle appears misaligned with the target charger, the system prompt may instead focus on requesting guidance for the user to reposition the target vehicle. Additionally or alternatively, the system prompt may be configured to elicit different types of LLM outputs including, for example, a natural language explanation to be presented to the user, a command to be transmitted to the target charger, and/or a clarification question requesting additional information from the user.

In some implementations, the system prompt may also include structured data fields or elements to guide the LLM's response or restrict output to a specific structure. For example, the system prompt may present information in a consistent key-value format, such as “charger_ID: 4; fault_code: E87; vehicle_model: Nissan Leaf,” followed by a natural language instruction such as “Describe likely causes and recommend next steps.” This structured system prompt format may help the LLM interpret the system prompt more accurately and/or generate responses that are well-aligned with the intended diagnostic or support objective. Additionally or alternatively, the system prompt may incorporate session-specific context based on historical charger activity, prior user interactions, and/or recent error states observed over the course of the charging session. For example, if the same user previously attempted to charge at the same charger and encountered error code E102, the system prompt may include a statement such as “The user previously experienced error E102 at this charger 11 days ago; the issue was resolved after the user reconnected the charging cable.” This may allow the LLM to suggest repeating the previously successful resolution. In another example, if the target charger has failed to charge during multiple recent charging sessions regardless of user, the system prompt may note “This charger has failed 3 out of the last 4 charging attempts,” potentially resulting in the LLM recommending contacting support or flagging the target charger for maintenance. As described further below, in certain cases, system prompts may be based on a particular user role, such as a support agent or technician, and may include fallback logic or clarification requests if earlier responses fail to resolve a detected issue.

In some implementations, the system prompt generated at step 134 may incorporate contextual data from a variety of sources, including charging site context (e.g., equipment availability, charging speed specifications, usage histories of chargers, charging pricing, and/or current environmental conditions), target charger information (e.g., status, troubleshooting guides, known failure modes, and/or component-level diagnostics). Additional contextual data may include general information related to electric vehicles (e.g., charging behavior, voltage levels, and/or temperature variation effects) and/or target vehicle information (e.g., charging speed limits, plug release instructions, and/or troubleshooting guides). This contextual data may enable system 102 to generate more accurate and relevant system prompts tailored to the charging issue faced by the user.

In some implementations, system prompt generation may be based on one or more additional factors. For example, if multiple faults or unsuccessful charging sessions are associated with the same target charger within a particular period, system 102 may indicate the recurring nature of this issue in the system prompt. Similarly, system 102 may adjust system prompts based on estimated electrical grid load and/or site-level charger occupancy during peak hours, for example allowing the LLM to account for this information when recommending a charging location and/or time. In some implementations, system 102 may use a template to form the system prompt based on available contextual data and expected model confidence. For example, system 102 may use a fallback system prompt format when limited user inputs and/or contextual data are available. Additionally or alternatively, system 102 may use an expanded system prompt format when detailed contextual information is available.

In some implementations, a prompt generation module may be responsible for constructing system prompts using data collected throughout process 120. The prompt generation module may be stored in memory and executable by one or more processors of computing system 103. The prompt generation module may combine inputs such as target charger status, user interaction, environmental features, and/or context data to form a structured and/or natural-language prompt.

In some implementations, visual data captured by the one or more cameras of system 102 may be processed using one or more techniques including, for example, object detection, image classification, and/or optical character recognition. For example, said techniques may be used to extract text-based information from the visual data that in turn may be used to form the system prompt. For example, system 102 may apply optical character recognition to a label and/or display screen visible in the visual data to extract an identifier, a status message, and/or a fault code. Similarly, if a license plate is visible in the visual data, optical character recognition may be used to extract the license plate number, which may in turn be linked to historical charging session data. In some implementations, zero-shot or trained object detection models may be used to identify visual features such as charging cords, plugs/connectors, target vehicle types, and/or user actions, which may then be converted into descriptive natural language statements (e.g., “the user is holding the charging cable,” “the charging port cover is open,” and/or “the target vehicle is misaligned with charger stall”). Additional features that may be detected include indicator lights (e.g., “the indicator light on the charger above the left cable is red”) and/or visible damage or an obstruction (e.g., “the vehicle has collided with the cabinet of the charger” and/or “the screen has been partially obscured by graffiti”).

Additional detected visual features may include, for example, visible damage to nearby physical structures such as safety bollards, dark or unlit charger screens suggesting power loss or system failure, user actions such as repeatedly tapping or swiping a credit card at the charger interface, and/or driver interaction with an emergency stop button. For example, pressing an emergency stop button may place the target charger into a fault state, requiring a subsequent user to twist the button or take another action to reset the target charger. System 102 may also detect the presence of a vehicle occupying a charging stall without being plugged in, which may trigger an alert to onsite personnel for enforcement (e.g., ticketing and/or towing) or user notification.

A resulting system prompt may be based on such information extracted from visual data and/or on the visual data itself. Such information may be combined with information input by the user and/or with contextual data, thereby forming a multi-source and optionally multimodal representation of the charging session and/or a specific charging issue faced by the user. For example, a system prompt may be constructed as follows: “A user at Station 2034 scanned QR code QR_2034 and is attempting to charge a Hyundai Ioniq 5. The left-side charging connector is visible, but the charger screen displays error code E87. Recent charger log data indicates two failed sessions at Station 2034 in the past 24 hours.” In this way, a system prompt may reflect integration of information from visual data (e.g., target charger user interface content and/or user action), information input by the user (e.g., target vehicle make and/or model), and/or contextual information such as static database content (e.g., charging station identification and/or log data), providing the LLM with enhanced awareness of the charging context.

In some implementations, generation of the system prompt may be performed by a set of software modules, each responsible for producing a portion of the prompt. For example, certain modules may retrieve structured data from databases or external APIs and convert that structured data into natural language text using predefined templates or logic-based formatting rules. Other modules may contribute static content such as example responses, charging instructions, and/or general reference material related to electric vehicles. In some implementations, LLMs or other models may participate in assembling or refining individual sections of an exemplary systems prompt. The outputs of these software modules may be aggregated to form a unified system prompt for the LLM.

As described above, such a multi-source system prompt is distinct from a traditional LLM prompt that may be generated based on user input. According to known techniques, users may be expected to articulate a question and/or provide relevant information related to a charging issue. However, during a charging session, users may not be aware of the relevant fault condition, their vehicle type, and/or the nature of the malfunction. Instead, users may only indicate a vague concern such as “the charger is not working.” Accordingly, system 102 may autonomously generate detailed system prompts based on visual data captured by the one or more cameras of the system, data associated with the target charger, and/or contextual data associated with the charging session, reducing reliance on specific user knowledge. The user's role may be limited to simple actions such as pointing a camera, selecting a vehicle make, and/or confirming a suggested resolution to a charging issue, while system 102 may complete the system prompt with more advanced inputs unavailable to the user (e.g., based on visual data, target charger data, and/or contextual data associated with the charging session).

This approach may thus address a gap in known charging support systems, which may rely on users to accurately describe a charging issue and/or navigate static troubleshooting resources. For example, conventional systems may prompt the user to identify the site or charging station number and describe the nature of the problem. However, in practice, drivers may not be able to determine the root cause of the issue; for example, whether it relates to the target charger, the target vehicle, network connectivity, and/or user error. By detecting in an automated manner visual and/or contextual data relevant to a charging issue, this dependency on user knowledge and manual input may be reduced. This in turn may enable accurate and proactive issue identification and resolution even in situations in which user input is minimal and/or ambiguous.

At step 136, system 102 may transmit the generated system prompt to the LLM. The LLM may run in the cloud, on a local device near the target charger, and/or as part of a system that routes tasks to different language models based on their respective strengths or capabilities. For example, a lightweight local language model may handle basic troubleshooting or UI guidance, while more complex diagnostic prompts may be sent to a cloud-based language model trained on technical documentation. For example, one multimodal model may specialize in interpreting inputs from visual data, while a different language model may handle natural language explanations and/or user-facing messages.

In some implementations, the LLM may be a transformer-based model, such as a generative pre-trained transformer (GPT), or may be a BERT-style encoder model. The LLM may also be a multimodal model configured to process both textual and visual inputs (e.g., image and/or video data) to generate a response. For example, the system prompt may include at least a portion of the visual data. The LLM may operate within a distributed computing environment, in which certain language models may be hosted on remote servers accessible over a wide area network, while other language models may be deployed locally, for example at or near the target charger and/or on a mobile device, enabling low-latency inference. For example, as mentioned above, a local language model may be used to handle routine or latency-sensitive prompts, while more complex prompts may be routed to a cloud-based language model optimized for general-purpose reasoning and/or access to external APIs.

In some implementations, system 102 may use a routing layer to select among multiple LLMs or language model variants based on factors such as prompt type and/or complexity, and/or computational system load. Additionally or alternatively, the LLM may be part of a function-calling architecture, in which the LLM is authorized to invoke specific functions and/or retrieve contextual data from internal and/or third-party systems before generating a final response. For example, the LLM may call a function to query a historical session log database to analyze information associated with the target charger, the target vehicle, and/or the user. For example, the LLM may query a historical session log database to determine whether the same user recently experienced an issue at the same charger (e.g., the same error code) and retrieve the previously applied resolution. For example, this may result in the LLM generating an output such as “The user previously experienced error E102 at this charger 11 days ago; the issue was resolved after the user reconnected the charging cable.”

In some implementations, an LLM module may be responsible for executing the LLM(s) as described above. The LLM module may be stored in memory and executable by one or more processors of computing system 103. The LLM module may support model selection (e.g., selecting between general-purpose models and domain-specific models) based on the content of the generated system prompt. The LLM module may be updated over time based on usage patterns and/or historical charging session data.

To reason effectively over system prompts based on data from multiple sources (e.g., based on visual data, target charger data, and/or contextual data associated with the charging session), the LLM may undergo targeted training. For example, the LLM may be trained using a combination of standard instruction datasets and custom datasets based on charging scenarios. For example, such custom datasets may be based on synthesized data and/or log-based data including descriptive text derived from visual data (e.g., license plate values, target charger display messages, and/or user actions), static contextual data (e.g., charger model, charger firmware version, vehicle make, and/or vehicle model), and/or user inputs and/or queries. Training datasets may include expected responses such as user messages, target charger control commands, and/or recommended actions for the user and/or a support agent. For multimodal models, training datasets may include visual data (e.g., images of chargers and/or vehicles). Such visual data may include textual annotations and/or captions to help the model understand and reason over both image and text-based inputs.

In some implementations, fine-tuning techniques may be applied to an existing foundation model to better align it with charging-related tasks. Such techniques may include, for example, low-rank adaptation, quantized low-rank adaptation, instruction tuning, prefix-tuning, prompt-tuning, and/or p-tuning, allowing selected parameters and/or weights of the model to be modified without retraining the entire network. Additionally or alternatively, reinforcement learning from human feedback may be used to reward model behaviors associated with successful interventions, such as generating outputs that reference relevant visual cues and/or charger context. These approaches may improve model performance in reasoning over system prompts involving multimodal, context-specific charging scenarios.

In some implementations, the LLM may call a function to retrieve charger-specific data such as known firmware bugs, part replacement history, and/or usage statistics associated with the identified hardware version of the target charger to inform an output explanation for presentation to the user and/or to confirm the relevance of a recommended escalation. Additionally or alternatively, the LLM may call a function to access vehicle-specific charging limits, manufacturer guidance, and/or connected vehicle diagnostics via an API to determine whether the charging behavior is expected based on the target vehicle's configuration. In some implementations, the LLM may call a function to retrieve site-level environmental data associated with the charging location (e.g., temperature, grid load, and/or local maintenance alerts) to assess whether external conditions may be affecting performance of the target charger. In some implementations, the LLM may call a function to consult a troubleshooting knowledge base, search charger fault patterns across the network, and/or simulate the effect of resetting the target charger based on similar past cases. These capabilities may enable the LLM to provide outputs that are not only relevant to the system prompt, but that take into consideration current and/or historical contextual data relevant to the target charger, target vehicle, user, and/or particular charging session.

In some implementations, a function module may be responsible for interpreting LLM outputs that include function calls. The function module may be stored in memory and executable by one or more processors of computing system 103. The function module may validate the requested function against the current state of system 102, check policy or safety constraints, validate function arguments, and execute the function (e.g., by querying a backend system, retrieving diagnostic data, and/or transmitting control commands to the target charger). In some implementations, system 102 may transmit a function call to the target charger, where the function call may be effective to modify operation of the target charger. The function call may be transmitted in response to receiving an output from the LLM including a function call to the target charger.

In some implementations, system 102 may also transmit a function call to a backend charging network associated with the target charger. Such function calls may be effective to report an issue associated with the target charger (e.g., a detected fault, damage, and/or a software malfunction) to a central system associated with the target charger. For example, upon classification of a charging issue in an output received from the LLM, system 102 may prepare and transmit a structured report including the target charger identifier, detected fault condition, and supporting contextual data. This in turn may enable a backend system to initiate corrective actions such as dispatching maintenance personnel and/or initiating a remote firmware update. For example, system 102 may transmit a function call to the charging network of the target charger, where the function call may be effective to report damage to the target charger, a software issue affecting the target charger, or both. The function call may be transmitted in response to receiving an output from the LLM including a function call to the charging network.

In some implementations, system 102 may transmit a function call to a user device such as a smartphone or tablet. The function call may instruct the user device to activate its camera and/or may prompt the user to capture additional visual data of the target charger and/or target vehicle. System 102 may transmit such a function call, for example, when visual confirmation may assist in resolving an issue and/or when system 102 detects insufficient environmental visibility and/or ambiguous target charger behavior. For example, system 102 may transmit a function call to a user device, where the function call may be effective to activate a camera on the user device and prompt the user to capture visual data depicting the target vehicle or the target charger. The function call may be transmitted in response to receiving an output from the LLM including a function call to the user device.

At step 138, system 102 may receive an output from the LLM. The output may include one or more of the following parameters: a natural language output for the user, a structured function call to the target charger and/or a front-end module on a device of the user, and/or a recommendation for an action to be taken by a backend or support agent. For example, the output from the LLM may recommend that the user reposition the charging cable of the target charger, request confirmation of the make and/or model of the target vehicle, and/or instruct system 102 to reset the target charger. In some implementations, function calls may be directed to a backend and/or cloud-based charge point management system controlling the target charger. Such function calls may be additional or alternative to function calls to software running on the target charger itself.

The output from the LLM may be parsed into one or more user interface elements corresponding to suggested actions, for example such actions may be displayed on a support interface. Such suggested actions may include, for example, sending a communication to the user and/or transmitting a command to modify the operational state of the target charger. In some implementations, as mentioned above, the output from the LLM may include one or more function calls to the target charger, the target vehicle, a device of the user, and/or a backend system used to display a support interface. Each function call may be effective to perform a contextually appropriate operation such as resetting the target charger, initiating one or more diagnostic collection operations, and/or reporting a fault condition to a backend system for further analysis and/or escalation.

In some implementations, a response interpretation module may analyze the output received from the LLM to identify actionable content and determine how it should be displayed to the user and/or a support agent. The response interpretation module may be stored in memory and executable by one or more processors of computing system 103. The response interpretation module may analyze elements of the output received from the LLM (e.g., natural language instructions, control commands, and/or clarification requests), and may apply decision logic to route the elements to an appropriate interface or execution point (e.g. a front-end module, an API, and/or the target charger). The response interpretation module may also track whether the output received from the LLM addresses the detected issue or whether follow-up system prompt generation is appropriate.

At step 140 of process 120, system 102 may act on the output of the LLM. This may include initiating charging using the target charger and based on an approved action (e.g., enabling power delivery), and/or displaying an instruction to the user on a front-end module of a device of the user and/or on a user interface of the target charger. The displayed instruction to the user may be visual (e.g., including an annotated image), textual, and/or interactive. For example, system 102 may charge the target vehicle using the target charger in accordance with the output from the LLM and/or may display an instruction to the user to charge the target vehicle using the target charger in accordance with the output from the LLM.

In some implementations, system 102 may display a step-by-step troubleshooting sequence on the user interface of the front-end module and/or the target charger. For example, system 102 may update the user interface to display the next step in the sequence once it detects that the user has completed the current step, such as by observing user actions in visual data captured by the one or more cameras positioned near the target charger. System 102 may monitor for physical actions related to components of the target charger and/or target vehicle (e.g., confirming that the user has connected the charging cable and/or tapped a card reader) and advance or adjust the troubleshooting sequence accordingly. If system 102 determines that a step in the troubleshooting sequence has not been completed within a predefined time period, or detects unexpected user behavior and/or ambiguity in the visual data, system 102 may trigger fallback logic. This may include requesting clarification from the user via a chat interface, providing additional guidance in response to a user query, and/or escalating the issue for remote support. In some implementations, system 102 may update the user interface of the front-end module and/or the target charger to highlight specific components (e.g., a charging connector and/or screen element of the target charger) using visual cues and/or annotations to guide the user in completing the troubleshooting step.

In some implementations, system 102 may monitor the charging session following step 140 to determine whether one or more issues associated with process 120 have been resolved. If system 102 determines that the one or more issues have not been resolved, system 102 may generate a follow-up system prompt, escalate the issue to a support agent, and/or display additional guidance for the user. Such charging session monitoring may include monitoring user actions based on captured visual data, checking target charger status updates, and/or evaluating responses provided by the user in a chat interface. Throughout process 120, system 102 may track session-specific context data including the operational state of the target charger, the identity of the target vehicle, user interactions with interface elements of the target charger (e.g., a touchscreen, a button, and/or a card reader), and/or previously generated system prompts. These context variables may be updated based on outputs received from the LLM and/or based on observed user behavior. Maintaining this contextual information enables the system to reason more accurately over time, adapt subsequent instructions or decisions, and/or support downstream processes such as session analysis and/or fault prediction.

As described in further detail below, in some implementations, system 102 may present user interface affordances for support agents through a backend interface, such as controls for transmitting communications to the user or commands to adjust the operational state of the target charger. Such a user interface may also display relevant contextual data, including, for example, target charger status information, visual data from the physical environment of the target charger, and/or interaction history from prior sessions associated with the target charger and/or user.

System 102 may associate a confidence score with each output received from the LLM based on the completeness of input data such as charging session contextual data and/or the historical accuracy of similar outputs. If the output confidence score does not meet a predefined threshold, system 102 may trigger fallback logic such as requesting additional contextual data, prompting the user for a visual data input (e.g., a captured image or video), and/or escalating the issue to a support agent. In some implementations, the output received from the LLM may include a classification that may be used to update a parameter of system 102, adjust an aspect of a user interface, and/or initiate a backend process, such as escalating a confirmed fault associated with the target charger.

In some implementations, system 102 may provide users with contextual estimates related to the charging session, such as expected charge duration and/or wait time based on current charger power delivery, vehicle characteristics, and/or recent performance data. These contextual estimates may be included in natural language outputs from the LLM. Upon completion of the charging session or successful issue resolution, system 102 may generate a charging session summary including observations, actions taken by the user and/or system 102, and/or the final charging session outcome.

In some implementations, system 102 may be configured to process still images, video clips, and/or video streams captured by one or more cameras monitoring the physical environment of the charger. For example, system 102 may generate bounding boxes and/or pixel segmentations around vehicles, users, license plates, and/or components of the target charger. Said bounding boxes and/or pixel segmentations may be associated with known charger stall (e.g., designated parking spaces at a charging station) identifiers and/or coordinates, enabling alignment with metadata from known databases. In some implementations, bounding boxes may also support detection of specific events such as one or more plug-in attempts, vandalism (e.g., spray painting and/or damaging the charger), and/or theft-related activities (e.g., cutting a charging cable). System 102 may draw visual overlays around relevant objects, such as a vehicle approaching a charger stall, a user interacting with a user interface of the target charger, and/or the charging port and/or charging cable.

Captured visual data may be further processed to detect a status of the target charger, for example to detect a state of disrepair. For example, system 102 may classify the target charger as being in good working order or exhibiting specific error states, such as an offline screen, an inoperable left or right cable, and/or exhibiting other visual indicators of malfunction. System 102 may also generate timestamped records of detected activity (e.g., when a user plugs in or unplugs a charging cable, interacts with a credit card reader, and/or enters or exits the target vehicle and/or the charging site). Identified license plates may be parsed using optical character recognition techniques, and vehicles in a frame of visual data may be classified by make, model, and/or year. In some implementations, system 102 may determine whether a vehicle appears to be waiting for a charger based on its position and/or behavior within a frame of visual data.

Object detection and/or segmentation may be carried out using trained or fine-tuned computer vision models based on labeled data. One source of such labeled data may include driver-submitted reports, for example resulting from a driver reporting a payment malfunction and captures a photo of a damaged payment terminal or card reader. Additionally or alternatively, object detection and/or segmentation may be carried out using zero-shot computer vision models that generate bounding boxes and/or masks based on visual data inputs. Similarly, classification tasks such as determining charger state, type of user behavior or action, and/or vehicle identification may be performed using trained classifiers or zero-shot image, video, or multimodal models. In some implementations, system 102 may generate video clips corresponding to detected events. System 102 may classify said video clips into predefined action types, such as “user attempted to pay for charging session,” “user plugged in the charging cable,” “user exited target vehicle,” or “user caused damage to the target charger.” Detected events may be associated with a known target charger based on visual proximity and/or alignment with known bounding boxes in a frame of visual data. In some implementations, classification of events such as “user caused damage to the target charger” may be corroborated using backend data and/or subsequent physical events. For example, after a suspected damage event, system 102 may detect that a subsequent user arrived, observed the target charger, and abandoned the charging session without initiating a plug-in or payment interaction. Additionally or alternatively, system 102 may determine that no further charging attempts or sessions were recorded at the target charger for a threshold period of time (e.g., several hours or days), further indicating that the target charger may have been rendered inoperable.

Analysis of visual data may be performed continuously and/or on demand. In implementations involving continuous analysis, system 102 may maintain a database of timestamped interaction events, charger stall occupancy records, and/or movement-based activity for reference by downstream processes. In implementations involving on-demand analysis, system 102 may process visual data upon user request, support agent interaction, and/or receipt of a function call. System 102 may similarly analyze visual data provided by a user device, such as a smartphone or camera-equipped wearable device (e.g. augmented-reality glasses). For example, system 102 may initiate a function call to access the user's device camera, prompt the user via a chat user interface to aim the camera at the target vehicle and/or target charger, and analyze the resulting visual data to identify the target vehicle make and/or model, and/or to extract information associated with the charger.

FIG. 1C depicts optional sub-steps corresponding to step 140 of process 120 in FIG. 1B. As described above, following generation and processing of the system prompt using the LLM, and receipt of an output from the LLM, process 120 may proceed to step 140, in which system 102 may charge the target vehicle using the target charger in accordance with the output from the LLM. In some implementations, this action may involve charging the target vehicle using parameters and/or procedures specified in the output from the LLM. In other implementations, system 102 may display an instruction to the user to charge the target vehicle, and/or may take automated steps to prepare the target charger and/or target vehicle for charging, in accordance with the output from the LLM. The actions taken at step 140 may thus be user-facing (e.g. facing a user of the target charger and/or a support agent) and/or system-executed, based on the nature of the output received from the LLM and the capabilities of the components involved.

For example, charging the target vehicle using the target charger in accordance with the output from the LLM may include, at step 142, system 102 transmitting a control command to the target charger. Such a control command may include resetting the target charger, modifying a power delivery setting (e.g., adjusting a voltage and/or current level) of the target charger, initiating a diagnostic operation (e.g., a self-diagnostic and/or status-reporting operation) on the target charger, and/or reporting a fault condition of the target charger, for example to a backend server or charging network. The control command may be issued based on a classification and/or recommendation produced by the LLM, and may be automatically transmitted to an internal controller and/or management system of the target charger. In some implementations, actions associated with transmitted control commands may be logged along with a specific hardware version and/or location of the target charger to support future troubleshooting and/or predictive maintenance. System 102 may additionally or alternatively retrieve operational state information associated with the target charger before and/or after execution of the transmitted control command to verify successful completion and/or to trigger escalation if a resolution is not achieved.

Additionally or alternatively, at step 144, system 102 may display an instruction to the user to charge the target vehicle. The instruction may appear on a user interface corresponding to a display of the target charger, and/or within a front-end module (e.g., a charging support application) running on a user device such as a smartphone and/or tablet. For example, displaying an instruction to the user to charge the target vehicle may include displaying the instruction to the user on a device of the user or a display of the target charger. The instruction may include natural language guidance generated based on the LLM output, and may reference target charger status, recommended user actions, and/or fault information relevant to the charging session. In some implementations, the instruction may be formatted as a direct recommendation (e.g., “Please reconnect the charging cable”), a warning message, and/or a clarification question intended to guide the user toward resolving an issue.

At step 146, system 102 may generate a visual and/or textual indication corresponding to a specific component of the target charger and/or target vehicle. For example, displaying an instruction to the user may include generating an indication corresponding to a component of the target charger or a component of the target vehicle. For example, said indication may be based on one or more features identified based on visual data corresponding to the physical environment of the target charger For example, system 102 may highlight the location of the charging connector of the target charger, the charging port cover of the target vehicle, and/or the card reader of the target charger. In some implementations, such locations may be highlighted using, for example, an overlay and/or animation on the user interface of the front-end module and/or target charger. By highlighting such locations, system 102 may help focus user attention on the area of the target charger and/or target vehicle associated with a troubleshooting step. Such highlighting may be of particular use in scenarios involving physical setup errors, and/or hardware configurations unfamiliar to the user.

Following step 146, at step 148, displaying an instruction to the user may include system 102 instructing the user to perform a physical action with respect to the component of the target charger and/or the component target vehicle indicated in step 146. This physical action may include, for example, connecting and/or disconnecting the charging cable of the target charger, opening a charging port cover of the target vehicle, interacting with a selectable control on the target charger and/or target vehicle, and/or repositioning the target vehicle. The instruction may include visual cues (e.g. audio, image, and/or video data), text instructions, or both. In some implementations, the instruction may be updated based on detected user activity, updated target charger and/or target vehicle status data, and/or elapsed time, allowing for real-time adjustment of the instruction.

In some implementations, at step 150, displaying an instruction to the user may include system 102 displaying a sequence of steps configured to guide the user in resolving a charging-related issue. In this way, the sequence of steps may form the step-by-step troubleshooting sequence described above. These steps may be determined based on the LLM output, the target charger type, the target vehicle make and/or model, and/or a known resolution sequence for a detected fault condition. Each step may include user instructions, visual cues, and/or progress indicators to facilitate completion. The sequence may be interactive, allowing the user to confirm each action, request help, and/or restart the sequence. In some implementations, the sequence may be tailored for novice users and/or for support agents, based on the context in which the instructions are being displayed.

At step 152, system 102 may monitor user activity based on visual data captured by one or more cameras positioned at or near the target charger. System 102 may use this visual data to detect whether the user has completed each step in the sequence of steps. For example, the user activity may be indicative of progress toward completing one or more of the sequence of steps. System 102 may observe whether, for example, a charging connector of the target charger has been plugged into a charging port of the target vehicle, a selectable control on the target charger and/or target vehicle has been activated, and/or a physical position of the target vehicle has changed. If completion of the current step is detected, system 102 may automatically advance to the next step. For example, displaying a step of the sequence of steps may be based on a determination that the user completed a prior step of the sequence of steps. If expected activity is not observed within a predefined time interval, system 102 may provide additional guidance, trigger fallback logic such as requesting user confirmation through a chat interface, and/or escalate the issue for remote support. Monitoring taking place at step 152 may additionally or alternatively be used to log session actions, verify step completion, and/or improve future instruction generation through feedback incorporation.

In this way, the output from the LLM may have one or more practical applications involving one or more of the target charger, the target vehicle, the user, and/or a support agent. For example, the LLM output may include one or more commands or structured instructions configured to directly modify a state of the target charger. For example, the output may specify a change in a power delivery setting, trigger a remote reset of the charger, initiate a diagnostic routine, and/or enable or disable a particular input mode. These actions may be performed automatically based on the LLM output and/or upon confirmation from the user and/or a support agent, and may enable or resume charging functionality. For example, if the target charger is in an error state or locked, the LLM output may include a function call that restores the target charger to an operable mode.

Additionally or alternatively, as mentioned above, the LLM output may support generation of user-facing guidance. Said guidance may include, for example, natural language responses generated for display on a user interface of a front-end module (e.g., a chat message displayed on a mobile application of a user device and/or on the target charger), and/or recommended actions for display on a backend support interface. Such guidance may include instructions to the user to perform actions including, for example, repositioning the target vehicle, reconnecting the charging cable, and/or scanning a QR code. Additionally or alternatively, said guidance may be constructed in a manner that does not assume user expertise, allowing users to complete the instructions with minimal background knowledge.

In some implementations, the LLM output may include an action that modifies a configuration and/or access control setting of the target charger, thereby enabling the user to complete a charging-related step. For example, if a target charger is configured to deny user input until a specific condition is met (e.g., payment confirmation and/or vehicle recognition), the LLM output may include a command to update this condition, thereby unlocking the target charger for user interaction. Additionally or alternatively, the LLM output may enable a temporary override of the target charger allowing the user to proceed with charging.

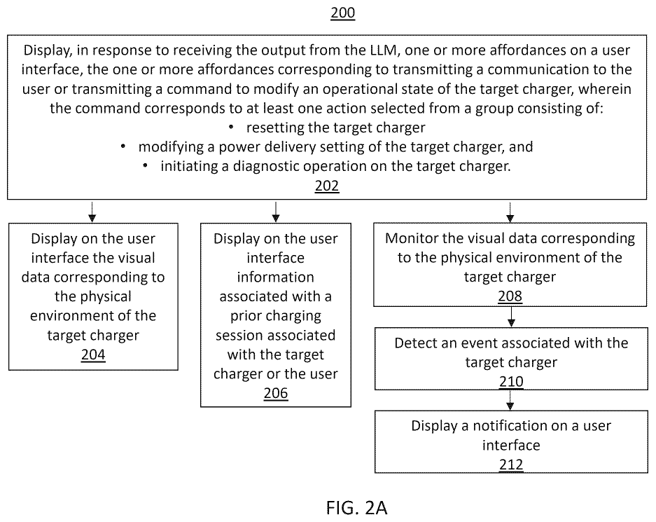

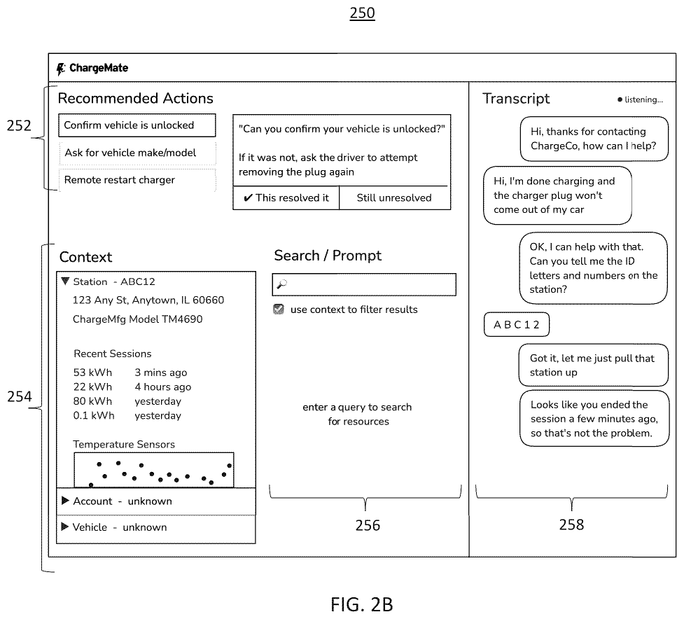

FIG. 2A depicts an exemplary process 200 for displaying affordances associated with charging a target vehicle using a target charger. For example, process 200 may enable display of a user interface supported by system 102. The user interface may in turn allow a charging network operator or technical support agent to oversee one or more chargers and/or user interactions with said charters. At step 202, system 102 may display one or more affordances (e.g., interactive interface elements) on the user interface in response to the output received from the LLM. These affordances may enable an operator to take system-level actions, such as transmitting a message to the user via a front-end module running on a device of the user and/or issuing a control command to the target charger. For example, the one or more affordances may correspond to transmitting a communication to the user or transmitting a command to modify an operational state of the target charger. The available control actions may include resetting the target charger, modifying a power delivery setting (e.g., voltage, current limit, and/or session timeout) of the target charger, and/or initiating a diagnostic operation on the target charger for example to retrieve logs, error states, and/or real-time performance metrics. These affordances may be displayed on the user interface as buttons, sliders, and/or selectable tiles, and may change based on the current status of the target charger, the current status of the target vehicle, and/or the classification of a detected issue. In some implementations, system 102 may use confidence scores and/or risk profiles to filter the set of available actions, prioritizing those that are most relevant and/or time-sensitive.

Following step 202, process 200 may proceed to one or more of steps 204, 206, and 208. At step 204, system 102 may display on the user interface visual data corresponding to the physical environment of the target charger. For example, the visual data may be captured by the one or more cameras of system 102. This visual data may include live video, recent image frames, and/or annotated visuals showing detected components, user interactions with the target charger and/or target vehicle, and/or regions of interest. Visual data may be cropped, enhanced, and/or filtered to emphasize relevant areas, such as the charging connector or user interface of the target charger. In some implementations, system 102 may overlay metadata and/or indicators onto the visual data. For example, system 102 may highlight where the user last interacted with the target charger and/or may flag areas where faults were previously detected. These visual overlays may assist a support agent in confirming the accuracy of the LLM output and/or in manually assessing environmental conditions that may be contributing to a charging issue.

At step 206, system 102 may display on the user interface information associated with a prior charging session associated with the target charger and/or the user. This information may include past session outcomes, previously reported faults, user-provided feedback, resolution history, and/or interaction logs. For example, if a user previously encountered a specific error code (e.g., E102) at the same charger and resolved it by reconnecting the cable, that information may be displayed on the user interface to guide current troubleshooting. Similarly, if a target charger has experienced repeated issues with particular hardware components or during specific environmental conditions (e.g., high temperatures and/or high electrical grid loads), this trend data may be displayed on the user interface to support a more informed response.

At step 208, system 102 may monitor the visual data corresponding to the physical environment of the target charger in real time to detect developments in the charging environment. Such monitoring may include tracking user motion, identifying changes to components of the target charger and/or target vehicle (e.g., opening and/or closing of the charging port of the target vehicle), monitoring environmental conditions (e.g., poor visibility due to precipitation and/or poor lighting), and/or detecting anomalies associated with the target charger such as an obstruction and/or evidence of tampering. Such monitoring may be based on object detection models to track users and/or specific charger and/or vehicle components, and/or on change detection methods to identify state transitions (e.g., the user interface of the target charger turning off, the charging cable being disconnected, and/or new objects appearing) between successive frames of the visual data.

Following step 208, at step 210, system 102 may detect an event associated with the target charger. As described above, such events may include a physical interaction (e.g., a user plugging in the charging connector of the target charger into the charging port of the target vehicle), a fault condition (e.g., an unexpected pause in power delivery), and/or behavioral anomalies (e.g., a user hesitating or appearing confused). In some implementations, behavioral anomalies may include visible signs of confusion or frustration, such as a user struggling with a mobile application, repeatedly tapping the screen, or scanning the same QR code multiple times. System 102 may apply sentiment analysis techniques to assess whether the driver appears frustrated, confused, neutral, or content, using a combination of visual cues (e.g., facial expression or body language), voice tone from voice-based interfaces, and/or textual input via chat interfaces. If confusion or frustration is inferred, the system may proactively suggest a targeted and simplified resolution to the user (e.g., “plug in and push hard until you hear a ‘click’ of the connector in your vehicle's charge port”) to improve usability and reduce the likelihood of the user abandoning the charging session.

Detected events may be classified using and/or associated with target charger communication logs and/or real-time operational signals collected during the charging session. Such operational signals may include metrics such as power delivery status, voltage and/or current levels, charging connector engagement state, and/or fault codes reported by the target charger. Combining the visual data with these additional data sources may enable system 102 to more accurately determine the cause, type and/or severity of a detected event. For example, with additional context, system 102 may determine whether a charging failure was caused by user error, software/firmware/hardware malfunction, and/or environmental interference. In some implementations, for example, the same event detected in the visual data may be classified and/or interpreted differently by system 102 based on whether target charger status data indicates that the target charger is idle, active, or in an error recovery mode.

In some implementations, system 102 may classify detected events as indicative of abnormal use of the target charger. Such detected event classifications may include, for example, unauthorized user interactions, improper charging connector handling, and/or atypical user access patterns. These detected event classifications may be based on historical user interaction data and/or predefined behavioral rules. Detected events may additionally or alternatively be classified as indicative of a fault condition of the target charger, including repeated charging failures and/or conflicting target charger readings.

Following detection of an event at step 210, at step 212, system 102 may display a notification on the user interface. This notification may include a description of the event, a timestamp, relevant imagery and/or contextual data (e.g., target charger communication logs and/or real-time operational signals), and/or suggested next steps. For support agents, notifications may be actionable, allowing responses such as acknowledging the event, contacting the user, and/or transmitting a control command to the target charger. In this way, system 102 may monitor the visual data corresponding to the physical environment of the target charger, detect an event associated with the target charger, and display a notification on a user interface in response to detecting the event.

FIG. 2B depicts an exemplary user interface 250 associated with charging a target vehicle using a target charger. For example, user interface 250 may form a backend user interface presented to a support agent or system administrator during a charging session involving the target charger and a user. User interface 250 may be displayed using one or more of the steps in process 200 described above in the context of FIG. 2A. User interface 250 may provide a centralized display of session-relevant data and/or user interaction tools, enabling support agents to efficiently resolve charging issues.

For example, user interface 250 may include a recommended actions section 252 that may display a prioritized list of system-suggested actions. These recommended actions may be based on the LLM output and may take into account recent data from the target charger and/or visual data captured by the one or more cameras of system 102. These recommended actions may include steps for the support agent to take (e.g., “Restart the target charger” and/or “Run hardware diagnostic”), as well as queries for the user (e.g., “Can you provide your vehicle's make/model” and/or “Can you confirm your vehicle is unlocked”).

System 102 may rank and/or filter recommended actions based on target charger hardware type, target charger software version, target charger fault history, and/or issue severity. For recommended actions corresponding to queries for the user, user interface 250 may allow the support agent to forward the queries directly to the user via a front-end module on the device of the user. User interface 250 may display buttons and/or checkboxes to record whether the recommended action resolved the issue. Additionally or alternatively, recommended actions may be accompanied by one or more affordances enabling a support agent to confirm or dismiss a particular suggested action. Recommended actions corresponding to steps for the support agent to take and/or queries for the user may include function calls previously generated by the LLM. Such function calls may include, for example, a reset command for the target charger, a request to activate the user's mobile device camera for further visual inspection, and/or a control signal to the target charger to initiate diagnostic data collection. Such function calls may be executable directly from user interface 250. For example, selecting a recommended action may initiate a corresponding control command and/or may generate a message for user communication.

For example, recommended actions may include: “Set user location context to Station 3345 at Old Orchard Mall,” “Ask user which payment method they tried,” “Search for Hyundai Ioniq 6 plug release,” “Send SMS message to user phone containing payment link for Station 3345,” “Send SMS message to user phone containing web app link allowing them to share a live video feed,” “Go through ‘stuck plug’ protocol with driver,” “Review recent charge attempt logs and user feedback for Station 3345,” and/or “Remotely restart Station 3345.” In addition to displaying recommended actions, system 102 may display corresponding affordances and/or data. For example, affordances may enable a support agent to set a value, conduct a search, send an SMS message and/or visual data, display a troubleshooting checklist, display summary and/or graph data, and/or modify the operation of the target charger for example by restarting the target charger.

A context section 254 may present aggregated data corresponding to the charging session environment and/or charger-specific metadata. Context section 254 may include the geographic location and/or station address of the target charger, local environmental readings such as ambient temperature and/or humidity, and/or usage history. Usage history may include, for example, a listing of recently completed charging sessions including total energy transferred during each session and/or completion time of each session. Context section 254 may additionally or alternatively include user account information (e.g., session ID, payment method, and/or subscription type) and/or vehicle-specific attributes if known, such as the make, model, and/or year of the target vehicle. Information displayed in context section 254 may be updated as new data and/or user responses become available, improving support agent awareness.

For example, context section 254 may display and allow modification of variables associated with the charging session including, for example, charging site and/or station identity, user account information, and/or target charger and/or target vehicle details. For example, user interface 250 may show live data associated with the target charger, recent logs associated with the target charger, and/or environmental data such as current weather conditions. A support agent may use user interface 250 to update and/or correct contextual data associated with the charging session based on a transcript of a chat with the user. For example, a support agent may modify the identity of the charging station and/or may correct the specified make and/or model of the target vehicle. For example, context section 254 may include recent activity history of the target charger (e.g., events from previous charging sessions at the same charger or station) and/or current charger or station status (e.g., online/offline state, available or in-use status, and/or recent fault history), thereby enabling more informed and efficient troubleshooting.

A search bar 256 may be provided within user interface 250 to enable manual lookup of technical documentation, target charger specifications, prior support cases, and/or known issue databases. Search bar 256 may include automatically generated suggestions based on keywords extracted from the current session context, and may support both natural language and structured query formats. For example, a support agent may search “error code E102 at charger 4” and retrieve relevant resolution steps, part replacement logs, and/or firmware updates associated with the issue. For example, search bar 256 may allow a support agent to retrieve internal and/or external knowledge base entries. For example, a support agent may search for “how to set the charge limit Tesla Model 3.” Contextual filters may restrict results returned to those relevant to the target vehicle and/or target charger in question.

A chat transcript section 258 may be provided within user interface 250. For example, chat transcript section 258 may include a running history of communications between the user and system 102, including both user-initiated messages and system-generated responses. The chat transcript may include natural language outputs from the LLM generated in response to user queries, clarification questions, diagnostic prompts, and/or any user confirmations or replies. Chat transcript section 258 may help support agents understand the progression of the charging session, identify whether the user has already received and acted on certain guidance, and/or determine whether fallback actions or escalation are appropriate. In some implementations, the chat transcript may be searchable to provide added context for support agents.

For example, chat transcript section 258 may show prior conversation history, including user interactions with an automated agent (e.g., system 102) and/or with a human support agent. In implementations including a live chat, chat transcript section 258 may allow a support agent to send messages directly to a user. In implementations including phone support, speech-to-text models may transcribe spoken dialogue from the user and/or support agent, optionally in real time. In some implementations, chat transcript section 258 may include an option for manual correction of transcription errors.

Following completion of a conversation with a user and/or resolution of a charging issue faced by the user, user interface 250 may support post-session data logging and/or analysis. For example, structured data may be stored and/or shared with other systems within a charging network. Quantitative metrics such as charging session duration, number of messages exchanged with the user, and/or issue resolution status may be recorded. Additionally or alternatively, qualitative analysis such as policy adherence, success of support agent interventions, and/or knowledge base gaps may be recorded. In some implementations, LLM prompts may be used to interpret the charging session and recommend follow-up actions and/or support documentation updates.

In addition or as an alternative to processes initiated by and/or based on user interaction and/or support agent interaction, system 102 may operate in response to external events and/or system-level alerts. For example, system 102 may respond to newly created support tickets and/or exceptions generated by third-party energy management platforms and/or charger management platforms. In some implementations, system 102 may produce structured outputs including, for example, comment entries on charging station tickets, outbound HTTP requests, and/or messages delivered via SMS, email, and/or push notifications to users, support agents, and/or charging site personnel.

In some implementations, structured LLM outputs may be used to generate user interface content separate from a chat user interface. For example, system 102 may generate a user interface with task-specific widgets and/or affordances derived from LLM reasoning, rather than presenting responses as unstructured text. Said widgets and/or affordances may allow a user and/or support agent to perform guided tasks and/or charging issue-specific workflows through button affordances and/or structured form fields.

One or more additional or alternative functions may be supported by system 102. For example, system 102 may support a point-of-interest or amenity search, based on the user's location, vehicle state, and/or dwell time at a charger (e.g., recommending a nearby restaurant and/or walking trail). For example, system 102 may support direct charging activation and/or payment, allowing users to initiate and/or pay for a charging session through a user interface associated with system 102. In some implementations, system 102 may enable activation of a charging session without payment if permitted by a charger operator (e.g., if a card reader is offline and/or nonfunctional).

### 1. Method for Facilitating Charging Sessions Between Electric Vehicles and Chargers

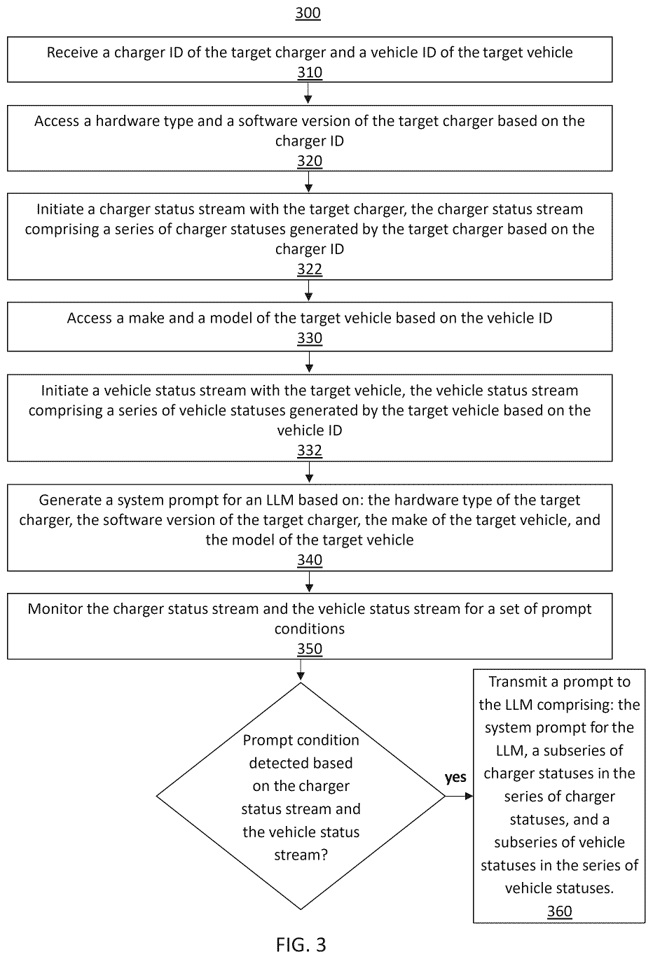

As shown in FIG. 3, a method 300 for facilitating a charging session between a target charger and target vehicle includes: receiving a charger ID of the target charger and a vehicle ID of the target vehicle in Step 310; accessing a hardware type and a software version of the target charger based on the charger ID in Step 320; initiating a charger status stream with the target charger, the charger status stream including a series of charger statuses generated by the target charger based on the charger ID in Step 322; accessing a make and a model of the target vehicle based on the vehicle ID in Step 330; initiating a vehicle status stream with the target vehicle, the vehicle status stream including a series of vehicle statuses generated by the target vehicle based on the vehicle ID in Step 332; generating a system prompt for an LLM based on the hardware type of the target charger, the firmware version of the target charger, the make of the target vehicle, and the model of the target vehicle in Step 340; monitoring the charger status stream and the vehicle status stream for a set of prompt conditions in Step 350; and in response to detecting a prompt condition in the set of prompt conditions based on the charger status stream and the vehicle status stream, transmitting a prompt to the LLM including the system prompt for the LLM, a subseries of charger statuses in the series of charger statuses, and a subseries of vehicle statuses in the series of vehicle statuses in Step 360.

### 2. Applications

As shown in FIG. 3, a distributed computer system (hereinafter, “the system”) executes a method 300 for facilitating charging sessions between electric vehicles and chargers (hereinafter, “the method 300”). More specifically, the system leverages real-time streams from a target charger and/or a target vehicle engaged in a charging session to identify potential technical issues that may occur during the charging session and communicate and troubleshoot these technical issues with a user. Additionally, the system retrieves technical specifications for both the target charger and the target vehicle, environmental data (e.g., temperature, current time of day, current day of the week, current estimated grid demand, and/or current estimated charging site usage) to generate a system prompt for an LLM module capable of accurately assessing charging issues and responding to user requests. Furthermore, the system can call functions based on a combination of user inputs, conditions of the charger and/or vehicle streams, environmental data, and/or technical specifications to modify the operation of the target charger or the target vehicle (e.g., via charger protocols, connected car APIs, and/or direct wireless connections), report technical issues with the target charger, and/or provide reliable predictions of charger performance. Thus, the system executes the method 300 to improve the user experience of charging an electric vehicle.

In one application of the method 300, the system can receive an error code via the charger stream during a charging session and, in response, prompt the LLM module to report the error code to the user with troubleshooting instructions. For example, in response to receiving an error code corresponding to a charger insertion error, the system can issue a prompt to the LLM module and transmit the response of the LLM module to the front-end module for presentation to the user. In this example, the system can transmit a prompt to the LLM module including the error code received via the charger stream and contextual information including technical specifications for the target charger. The LLM module may then transmit a message to the user, such as “We noticed that the connection between your charger and your vehicle may not be secure. Please make sure the plug is fully inserted into your charging port.” Thus, by providing real-time notifications and instructions to the user during a charging session, the system improves the user's experience by mitigating the amount of time required to troubleshoot charging issues and ensures a successful charging session during the user's visit (i.e., visit success).

In another application, the system can receive a message from the user and transmit this message to the LLM module in addition to a system prompt including the most recent series of status codes from the charger stream and the vehicle stream, the technical specifications for the charger and the vehicle, and environmental data. The system can then receive an output from the LLM responding to the user's message and transmit this output to the front-end module for presentation to the user. For example, the system can transmit a response to the user stating “Based on the issues you've reported, it seems like your vehicle may have a charging limit set at 80%. If you would like to continue charging, please update your vehicle's settings to remove this charging limit.” Thus, the system can directly respond to user-initiated questions about their charging experience.

In yet another application, the system can receive a message from the user or detect a condition within the charger stream and/or the vehicle stream and, in response, transmit a prompt to the LLM module including a set of functions that can be called by the system. This set of functions can include functions to report technical failures directly to a charging site backend, functions that modify the operation of either the target charger or the target vehicle (e.g., resetting the target charger, removing charging limits, or updating charging schedules of the target vehicle), functions capable of accurately estimating the charging time for the combination of the target charger and the target vehicle, functions capable of retrieving local points of interest or amenities. The LLM module may then respond by calling one or more of the set of functions. The system can then execute the one or more functions and transmit the output of the one or more functions to the LLM module. The LLM module may then generate an output responding to the user, and the system can transmit this output to the front-end module for presentation to the user. For example, the user may transmit a message to the system via the front-end module stating “My charger is not working and is not recognizing my vehicle when I plug it in.” In this example, the system can submit a prompt to the LLM module, call a function to reset the target charger in response to an output of the LLM module, transmit the result of the function call to the LLM module, and transmit a second output of the LLM module to the front-end application. In this example, the system may respond to the user via the front-end module with the message “Thank you for reporting this issue; I've successfully reset the charger. Please try to initiate your charging session again. Let me know if the issue persists, and I can provide further assistance.” Thus, the system can initiate troubleshooting actions without human intervention, thereby improving the charging experience for users and the rate of successful paid charges for charging network operators.

### 3. System

Generally, the method 300 is executed by the system, which includes one or more distributed computational devices such as servers connected via a local or wide area network such as the internet. Additionally, the system can include mobile devices such as smartphones, tablet computers, smart car computational devices integrated with the target vehicle (e.g., a smart car API connection to the computer of the target vehicle and/or third-party devices enabling tracking of the target vehicle), and/or computational devices integrated with the target charger, which can execute various Steps of the method 300. Steps of the method 300 can include the execution of various software modules by the system. In some implementations, software modules such as the LLM module and/or the function module can be executed by third-party systems in communication with the system.

### 3.1. Front-End Module

Generally, the system can execute, or communicate with a third-party system executing, a front-end model configured to: receive user inputs in the form of text messages, audio data, image data, and/or video data; and display outputs of the method 300 to the user. More specifically, the front-end module is configured to render a user interface capable of displaying and receiving multimodal data. In one implementation, the front-end module can utilize a camera of a smartphone or other device executing the front-end module to scan QR codes or capture images of the target charger and/or the target vehicle (e.g., to identify the charger type and the make, model, year, and/or trim of the target vehicle respectively). In another implementation, the front-end module can utilize wireless functionality of a smartphone or other device executing the front-end module to initiate a wireless connection with the target charger and/or the target vehicle. Thus, the front-end module enables interaction between the user and the system and aids in establishing direct connections with the target charger and/or the target vehicle.

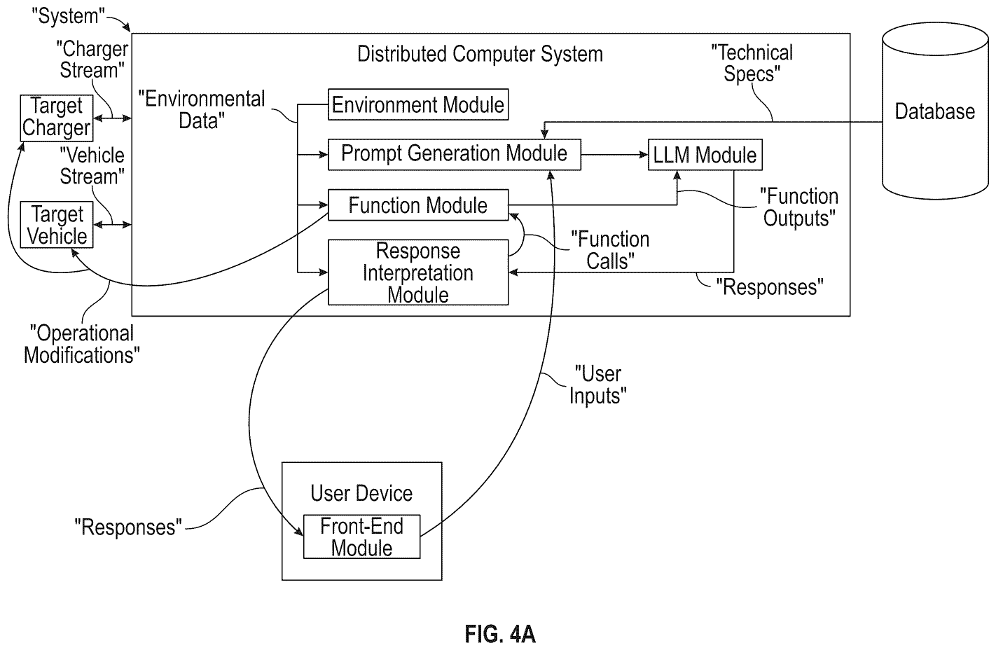

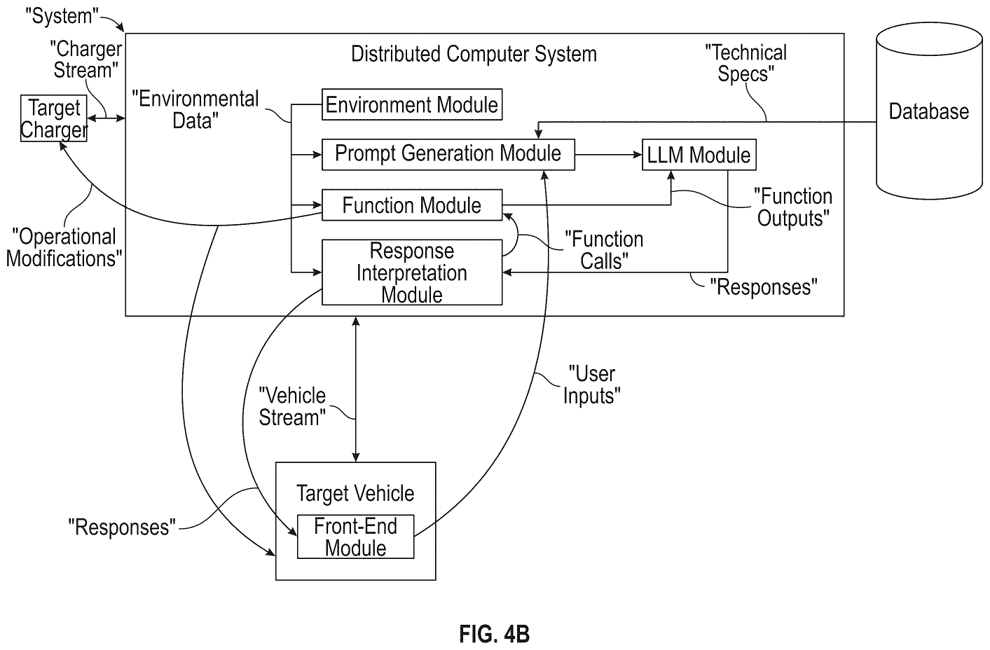

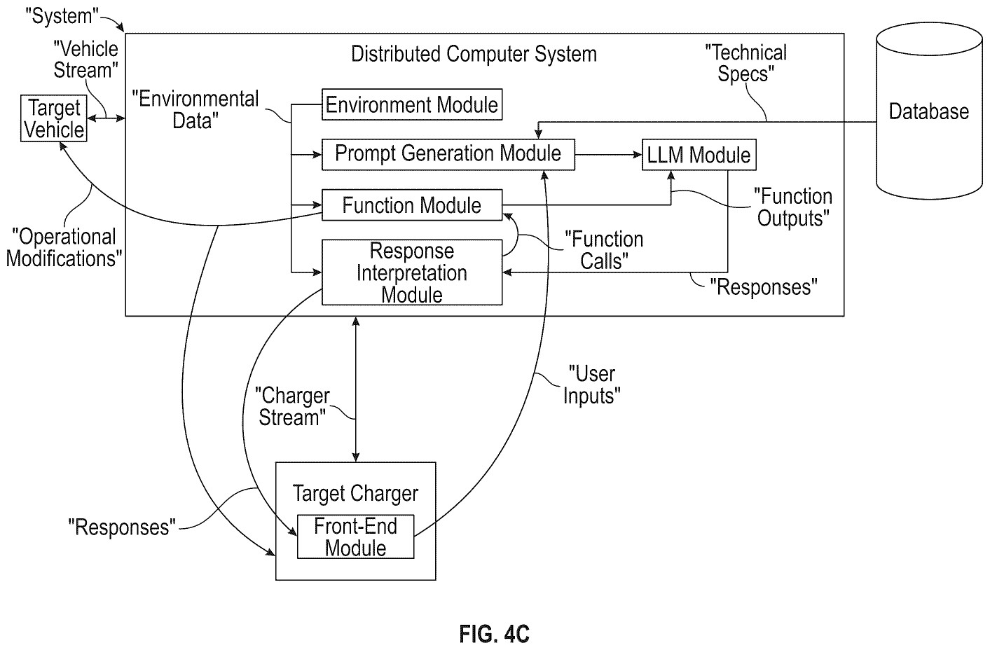

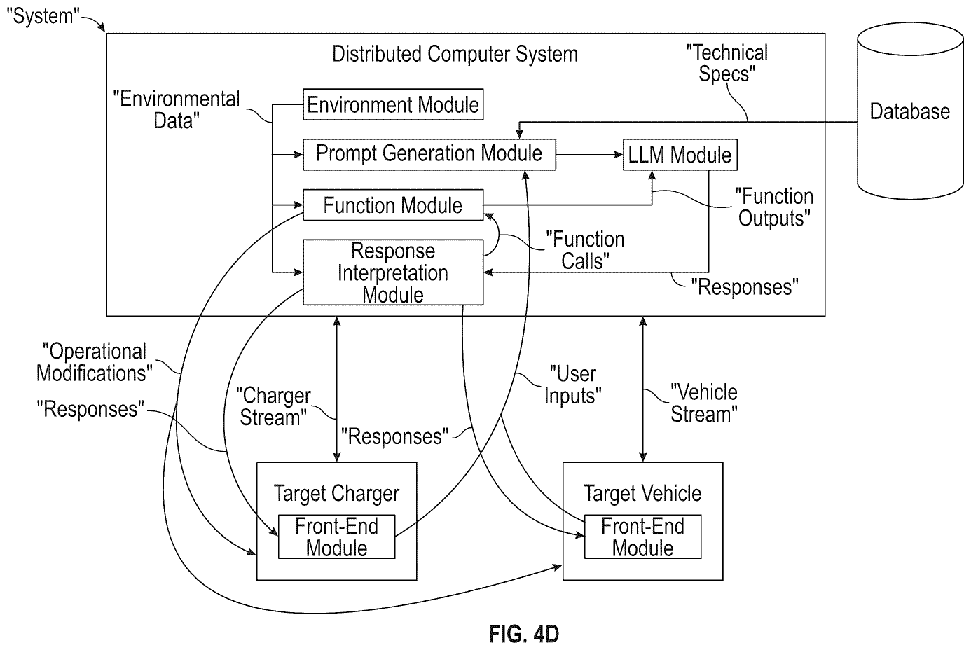

As shown in FIG. 4A, the front-end module can execute via a web application within a browser application on a user's mobile computational device (e.g., smartphone, tablet, or augmented reality device). In this implementation, the system communicates with the front-end module over the internet or a local area network and can include Steps of the method 300 executed by the front-end module. Thus, in this implementation, Steps of the method 300 can be executed by the system, by the user's mobile computational device, or both.

As shown in FIG. 4B, the front-end module can execute via a native application on a vehicle-integrated computational device (such as a vehicle infotainment system or smart-car system) of the target vehicle. In this implementation, the method 300 can be executed locally at the vehicle-integrated computational device and can include Steps of the method 300 executed by the front-end module. Alternatively, the system can communicate with the front-end module over the internet or a local area network. Thus, in this implementation, Steps of the method 300 can be executed by the system, by the vehicle-integrated computational device, or both.

As shown in FIG. 4C, the front-end module can execute via a native application on a charger-integrated computational device within the target charger. In this implementation, the system can operate locally at the charger-integrated computational device of the target charger. In this implementation, the Steps of the method 300 can be executed locally at the charger-integrated computational device and can include Steps of the method 300 executed by the front-end module. Alternatively, the system can communicate with the front-end module over the internet or local area network. Thus, in this implementation, Steps of the method 300 can be executed by the system, by the charger-integrated computational device, or both.

As shown in FIG. 4D, instances of the front-end module can execute on native applications on a vehicle-integrated computational device and a charger-integrated computational device. In this implementation, each front-end module communicates with each other and with the system over the internet or directly via a local-area network. Thus, in this implementation, the system can communicate with two separate front-end modules simultaneously to offer multiple options for communication with the user.

In one implementation, the front-end module can render various user interfaces, thereby enabling the user to interact with the system. In one example, the front-end application can render a conversation view of prior user inputs and LLM responses. Additionally, the front-end module can include a text input field, a UI element enabling recording, transmission, and/or streaming of user audio, inputs, and/or a UI element enabling recording, transmission, and/or streaming of user image and/or video inputs.

In another implementation, the front-end module can selectively render survey elements to ask the user to select from a predetermined list of options. For example, the front-end module can generate a survey UI element requesting that the user rate his or her charging experience (e.g., a number of stars out of 5, or a satisfaction rating out of 10 for a Net Promoter Score). In another example, the front-end module can generate a survey UI element requesting that the user select a charging issue he or she is experiencing from a list of possible options. Thus, the front-end module can render multiple options to enable users to interact with the system and the LLM module.

In implementations in which the front-end module is executed by an augmented reality device, the front-end module can render augmented reality visualizations or overlays to direct the user to perform an operation on the target charger, to report damage to the target charger, and/or to convey any other information related to the charging session. For example, the front-end module can highlight buttons, touchscreens, levers, or other means of controlling the charger in addition to an LLM response instructing the user on how to operate the target charger. In another example, the front-end module can prompt the user to draw (e.g., via gestures and/or an input interface of the augmented reality device) a bounding box around a damaged component of the target charger. Thus, the front-end module can render detailed augmented reality instructions to guide the user and improve the user's ability to effectively charge his or her vehicle with the target charger.

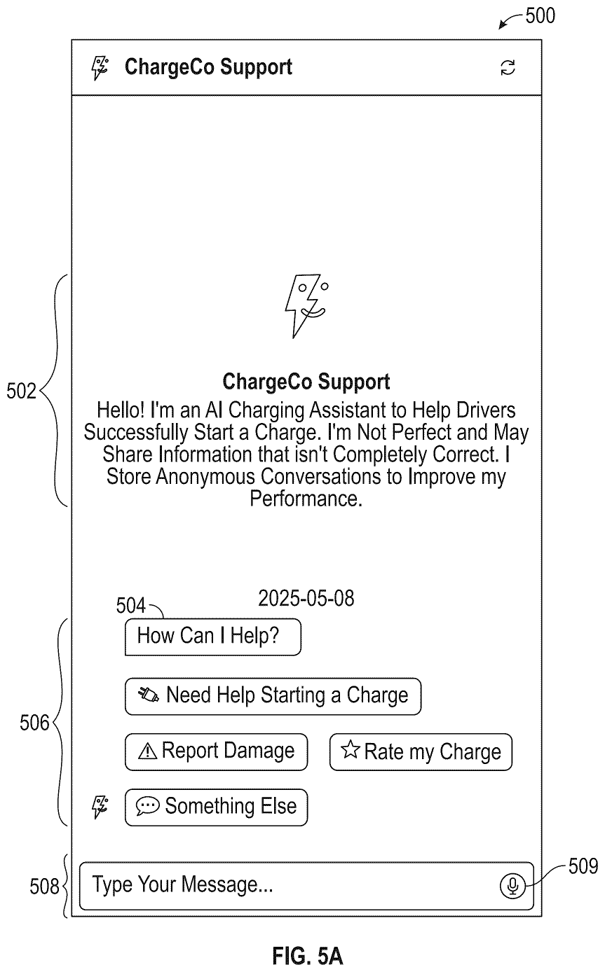

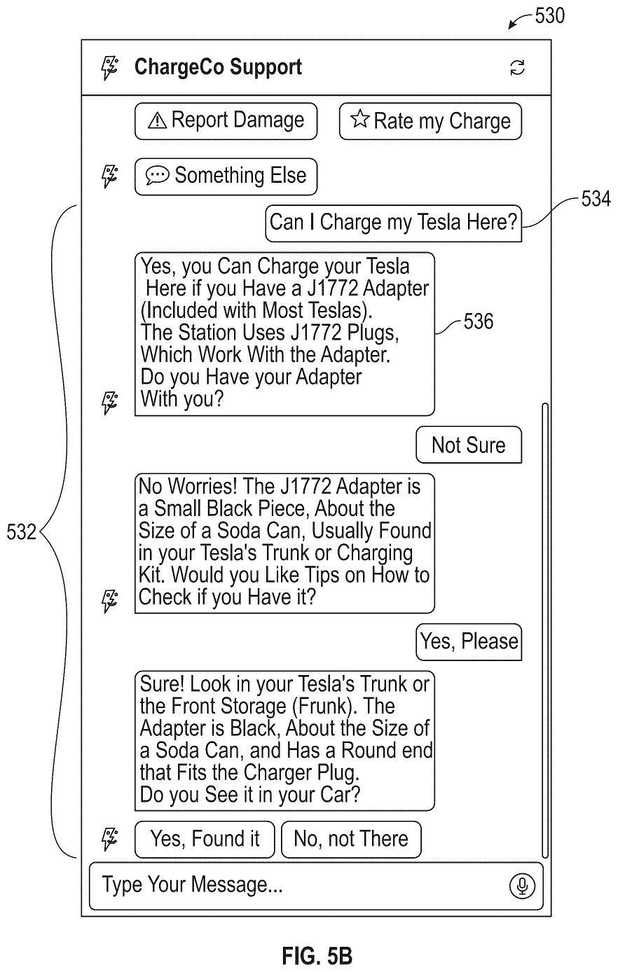

FIG. 5A depicts a view 500 of an exemplary chat user interface of a front-end module that may be executed on a user device, the target charger, and/or the target vehicle. The user interface is shown in a conversation mode in which system 102 may interact with a user through a message-based exchange. The user interface may include an introduction section 502 explaining system 102's purpose and/or limitations. Below introduction section 502, an initial system message 504 may be displayed to prompt a response from the user. In addition to initial system message 504, the user interface may present a set of affordances including response options 506, such as “Need help starting a charge,” “Report damage,” and/or “Rate my charge.” Response options 506 may thus serve as inputs to guide a user in conversing with system 102. A text-entry field 508 may allow the user to type a query or message for system 102, while a voice entry affordance 509 may enable spoken input through a microphone associated with the device of the user, the target charger, and/or the target vehicle.

FIG. 5B depicts a view 530 including a continuation of the exemplary chat user interface shown in view 500 of FIG. 5A, including a chat exchange between system 102 and the user. A chat transcript 532 is displayed, including a sequence of user and system messages, enabling the user to review previously sent and received messages. In the example shown, a typed user response 534 (e.g., “Can I charge my Tesla here?”) caused system 102 to respond with a subsequent system response 536 providing information and guidance based on charger compatibility. The conversation proceeds through multiple steps, with system 102 offering explanations and questions, and the user responding by selecting response options or entering text. One or more of the responses in chat transcript 532 may be generated by entering text into a text-entry field and/or by selecting from response affordances generated by system 102 and corresponding to predefined input options (e.g. similar to response options 506 depicted in FIG. 5A).

Each system response shown in chat transcript 532 may correspond to a separate system prompt generated and submitted to the LLM as described above in the context of process 120. Each system response shown in chat transcript 532 may be based on output received from the LLM, which may vary depending on the evolving context of the conversation, newly received user input, and/or updated target charger status data, target vehicle status data, and/or environmental data. This chat user interface may thus enable system 102 to engage in multi-turn interactions that facilitate step-by-step troubleshooting, target charger compatibility verification, and/or question-and-answer exchanges with the user. Through these interactions, system 102 may progressively gather the information associated with building a more complete picture of the charging session, identify a cause of a charging issue faced by the user, and/or guide the user toward a resolution of the issue.

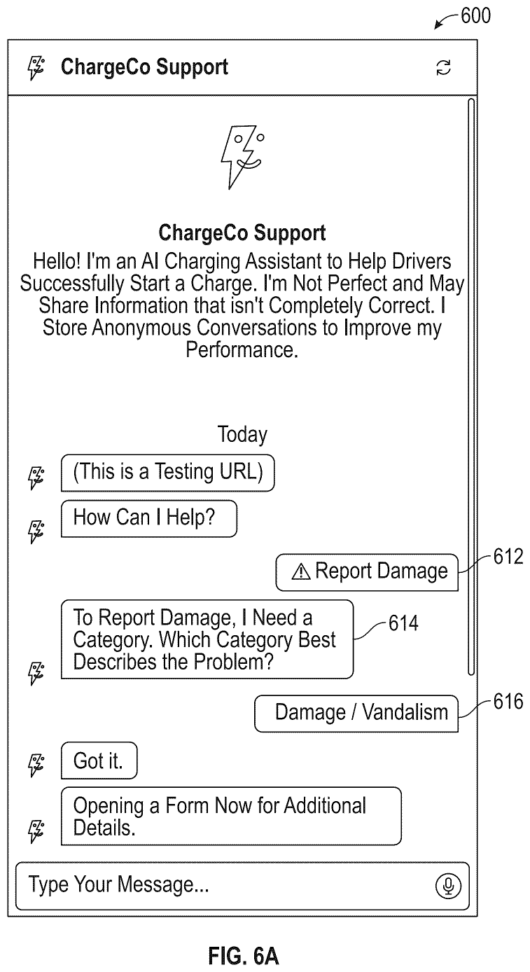

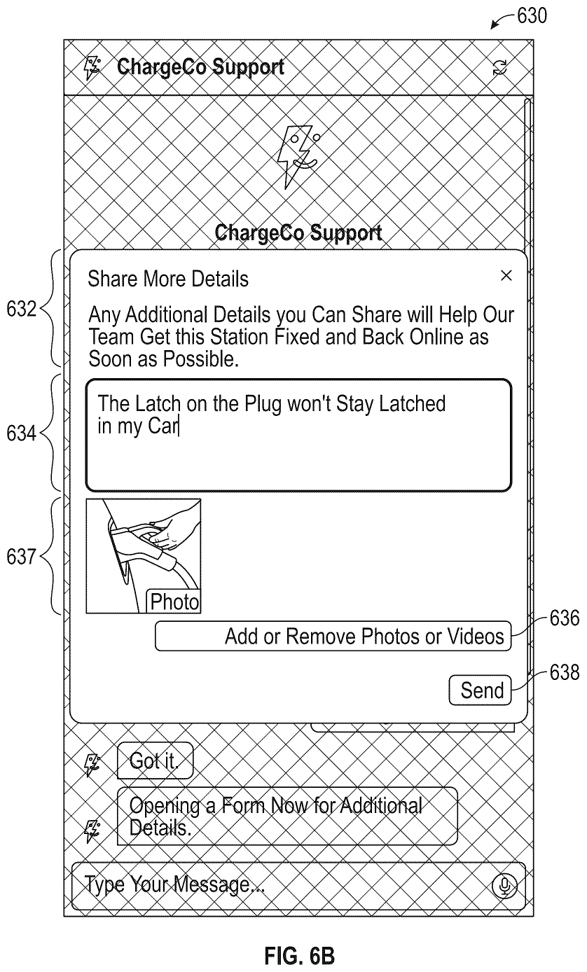

FIG. 6A depicts a view 600 of an exemplary chat user interface of a front-end module that may be executed on a user device, the target charger, and/or the target vehicle. View 600 illustrates a conversation in which a user initiates a damage report for a target charger. As shown in view 600, an initial user message 612 (e.g., “Report damage”) may be received by system 102, triggering a system response 614 requesting the user to select a category that best describes the issue. The user may then provide a user response 616 (e.g., “Damage/vandalism”) identifying the nature of the issue. One or both of initial user message 612 and user response 616 may be generated by entering text into a text-entry field and/or by selecting from response affordances generated by system 102 and corresponding to predefined input options (e.g. similar to response options 506 depicted in FIG. 5A).

In some implementations, system 102 may additionally or alternatively operate in a passive monitoring mode in which visual data from the one or more cameras positioned near the target charger is continuously analyzed to detect certain events without any user input. For example, system 102 may detect and classify an act of vandalism based on patterns observed in a video stream and may be configured to autonomously trigger a notification to a charger operator or support system in response to such detection. This monitoring may be performed in parallel with or independently from user reports of vandalism discussed in the context of FIG. 6A.

FIG. 6B depicts a view 630 of the same exemplary chat user interface following the exchange shown in view 600 of FIG. 6A. View 630 includes an input window displayed as an overlay on top of the existing chat interface, allowing the user to provide additional information related to the reported issue. The input window may include a system message 632 requesting additional details, a text-entry field 634, an affordance 636 enabling the user to attach a photo or video (e.g., photo 637) depicting the damaged and/or vandalized charger, and an affordance 638 enabling the user to send the entered details. This data entry capability may enable more complete and structured reporting of physical charger issues, and may support downstream analysis and/or intervention by system 102 and/or a support agent.

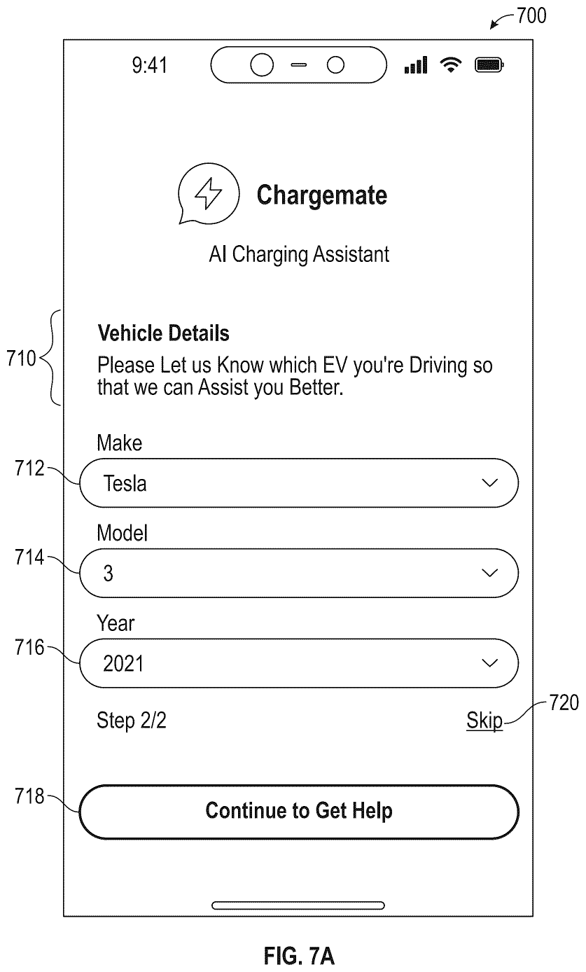

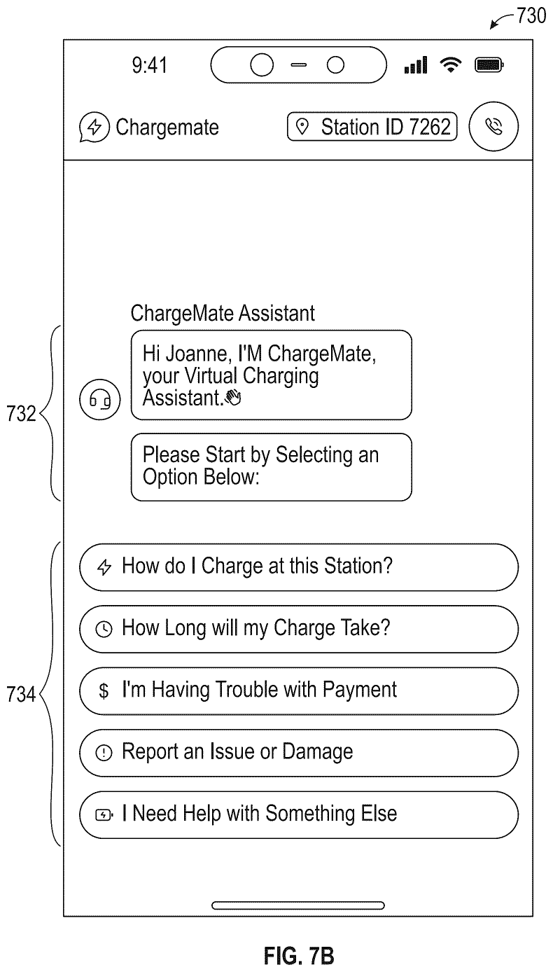

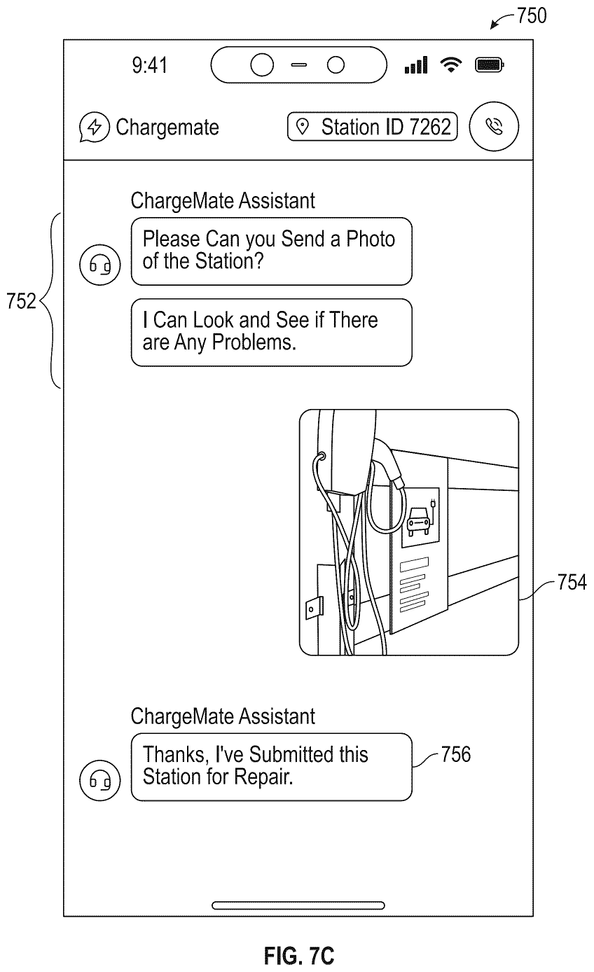

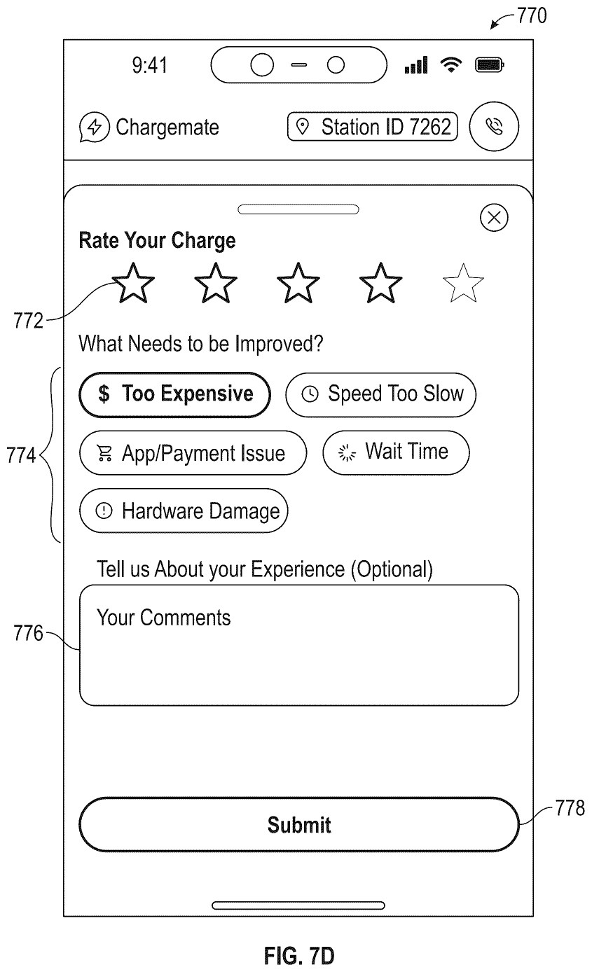

FIG. 7A depicts a view 700 of an exemplary user interface of a front-end module configured to receive information about a target vehicle. The user interface may prompt the user to enter the make, model, and year of the target vehicle using a set of dropdown menu affordances 712, 714, and 716, respectively. Such dropdown menu affordances may be used in addition to or as an alternative to text and/or voice prompts provided by the LLM via a chat interface to receive details of the target vehicle from the user. A continuation affordance 718 may be selected to advance to a chat user interface for assistance with a charging issue. A skip affordance 720 may also be presented, allowing the user to proceed without entering vehicle details.

FIG. 7B depicts a view 730 of an exemplary chat user interface including a system message 732 that may be configured to introduce system 102 as a virtual assistant for charging-related support. The chat user interface may also include a set of response affordances such as response options 734 that may allow the user to select a predefined query such as “How do I charge at this station?” or “How long will my charge take?” These response options may be used to retrieve contextual information and/or guide system 102 in generating a system prompt for LLM processing.

FIG. 7C depicts a view 750 of an exemplary chat user interface corresponding to a request for visual data from the user. A system message 752 may ask the user to provide a photo of the target charger, for example to aid in identifying the type of the target charger and/or in diagnosing a physical issue with the target charger. In the exchange depicted in view 750, the user responds with a photo 754 of the target charger, and system 102 provides a system response 756 indicating that the photo has been received and submitted for further processing.

FIG. 7D depicts a view 770 including an exemplary overlay input window for providing feedback on a charging session. The input window may include a rating affordance 772 allowing the user to select from one to five stars to indicate satisfaction with the charging session. The overlay input window may additionally or alternatively include a set of response affordances 774, enabling the user to specify which aspect(s) of the charging session could be improved (e.g., charger availability, charging speed, and/or charging cost). The overlay input window may additionally or alternatively include a text-entry field 776 enabling the user to enter additional details, and a submission affordance 778 enabling the user to transmit the feedback to system 102.

### 3.2. Charger Stream

Generally, the system can initiate a charger stream to send and receive data to and from the target charger respectively. More specifically, the system can initiate a charger stream based on a charger ID received from the front-end module or stored locally by the system. In particular, the system can initiate a charger stream via the Open Charge Point Protocol (hereinafter, “OCPP”) or via an application programming interface (hereinafter, “API”) exposed by the charging network operator of the target charger. The charger stream can include a timestamped series of charger statuses during a charging session indicating the target charger's charging state, charging rate, error codes, and/or any other characteristics or data relevant to the target charger. Thus, the system initiates a charger stream to obtain information about the operation of the target charger.

In some implementations, in which the method 300 is executed locally at a charger-integrated computational device, the method 300 can include directly accessing a series of charger statuses on the charger-integrated computational device.

In some implementations, the system executes Steps of the method 300 without initiating a charger stream due to technical difficulties or lack of integration between the system and the target charger's network.

### 3.3. Vehicle Stream

Generally, the system can initiate a vehicle stream to send and receive data to and from the target vehicle respectively. More specifically, the system can initiate a vehicle stream based on a vehicle ID received from the front-end module or stored locally by the system (e.g., in association with a phone number or other identifying information of the user). In particular, the system can initiate the vehicle stream via a connected car API. The vehicle stream can include a timestamped series of vehicle statuses indicating the vehicle battery's state of charge, current charging state, error codes, and/or any other information relevant to the charging session that is available to the vehicle.

In some implementations in which the method 300 is executed locally at a vehicle-integrated computational device, the method 300 can include directly accessing a series of vehicle statuses on the vehicle-integrated computational device.

In some implementations, the system executes Steps of the method 300 without initiating a vehicle stream due to technical difficulties or lack of integration between the system and the target vehicle's integrated computational devices.

### 3.4. Environment Module

Generally, the system can execute an environment module to access or retrieve current and historical data about the environment of the charging session to inform the system prompt for the LLM module and/or to provide input parameters for functions of the function module. More specifically, the system can access or retrieve environmental data such as the current temperature, the current time of day, the current day of the week, the current date, the current (or estimated) grid electricity demand, current (or estimated) grid supply composition (e.g., the proportion of renewable to fossil fuel energy sources), local charging site usage and/or bandwidth, and/or any other environmental data that may be relevant to the charging session. The system can execute an environment module that accesses environmental data from third-party sources over a wide area network such as the internet or via existing connections with a charging provider network, electric utility, or weather database.

In one implementation, the system, via the environment module can initiate environmental data streams to obtain live information pertaining to conditions at the charging site. Thus, the environment module enables the system to provide more accurate estimates of charging time, charging cost, carbon intensity of grid-generated electricity, and/or any other responses to users about a charging session that benefit in accuracy from real-time environmental data streams.

### 3.5. Prompt Generation Module

Generally, the system can execute a prompt generation module to monitor the charger stream, the vehicle stream, user inputs from the front-end module, environment data from the environment module, and/or function outputs from the function module (i.e., input data) and responsively compose and transmit prompts to the LLM module. More specifically, the prompt generation module can evaluate a set of prompt conditions and, in response to identifying a prompt condition based on the input data, compose and transmit a prompt to the LLM module. Thus, the system, via the prompt generation module can selectively construct prompts for the LLM by drawing from the input data available.

In one implementation, the prompt generation module can itself utilize an evaluation model to identify and respond to a predetermined set of prompt conditions. In this implementation, the prompt generation module can directly execute an evaluation model or communicate with a third-party server configured with the evaluation model. In one example of this implementation, the prompt generation module executes an evaluation LLM as the evaluation model. In this example, the evaluation LLM can be configured with a system prompt that includes the set of prompt conditions and instructions to evaluate each prompt submitted to the evaluation LLM for relevance to the set of prompt conditions. Alternatively, the system can train an evaluation model using a supervised learning algorithm and the set of prompt conditions to ensure that the evaluation model accurately identifies situations requiring LLM engagement with the user.

In another implementation, the prompt generation module is configured with conditional statements that evaluate the set of prompt conditions and compose prompts to the LLM module accordingly. Thus, the prompt generation module can utilize traditional code to interpret input data and compose prompts for the LLM module.

### 3.6. LLM Module

Generally, the system can execute an LLM module or communicate with an LLM module executed on a third-party server to receive and respond to prompts generated by the prompt generation module. More specifically, the LLM module receives prompts from the prompt generation module and generates responses for interpretation by the response interpretation module. In one implementation, the system executes the LLM module locally within the system. Alternatively, the system can communicate with an external LLM module via a local or wide area network such as the internet.

### 3.7. Response Interpretation Module

Generally, the system can execute a response interpretation module to identify responses from the LLM module intended for further transmission to the front-end module and subsequent presentation to the user. Additionally, the response interpretation module can identify responses from the LLM module calling functions via the function module. In one implementation, the response interpretation module utilizes a lookup table to track the functions made available by the function module. In response to detecting a function call present in the lookup table, the response interpretation module transmits the parameters in the response to the function module for execution.

### 3.8. Function Module

Generally, the system can execute a function module that calls functions (e.g., locally executing code and/or API requests to third-party systems) based on responses of the LLM module. More specifically, the function module can execute a set of functions that modify the operation of the target charger (e.g., resetting the target charger, initiating a charging session, stopping a charging session, changing charging mode) or the target vehicle (e.g., modifying existing charging schedules, removing or setting charging limits, issuing stop or start charging commands). Additionally and alternatively, the function module can execute functions that calculate or retrieve specific values, such as an estimated charging time remaining in the charging session to a given state of charge or a list of amenities near the charging site. Furthermore, the function module can execute functions that populate work orders or request replacement parts for the target charger within an internal queue for the charging network operator. Thus, the function module provides additional capabilities of the LLM module that enable practical and real-time improvements to the user's experience during a charging session between the target charger and the target vehicle.

### 4. Identifying a Charging Session

Generally, the system can identify a charging session (or an attempted charging session) between a target charger and a target vehicle to prepare a system prompt and gather the relevant context to facilitate the charging session. More specifically, the system can identify a charging session to access or receive a charger ID representing the target charger and/or a vehicle ID representing the target vehicle, initiate a charger stream and/or a vehicle stream, access technical specifications for the target charger and/or the target vehicle, access environment data relevant to the charging session, and generate a system prompt for the LLM module that provides context for the charging session. Thus, the system is capable of identifying charging sessions or attempted charging sessions occurring in real time in order to actively facilitate these charging sessions.

In one implementation, the system identifies that a charging session is occurring via a signal transmitted from the front-end module. For example, in an implementation in which the front-end module is a web application executing on a user's mobile computation device, the system can receive a signal from the front-end module indicating the user has initiated a charging session and opened the web application to interact with the system. In this implementation, the front-end module can direct the user to provide a charger ID associated with the target charger (e.g., by scanning a QR code located on the target charger, by detecting an RFID or other wireless signal transmitted by the target charger, by entering an ID directly into the front-end module, and/or by recording an image of the target charger). Additionally, in this implementation, the front-end module can direct the user to provide a vehicle ID or another ID (e.g., a phone number, username, and/or payment information) with which the system can look up a vehicle ID. Additionally or alternatively, the system can directly receive characteristics of the target charger, such as a hardware and software version of the charger and/or characteristics of the target vehicle, such as the make, model, year, and/or trim of the vehicle, without receiving or accessing the particular charger ID or vehicle ID of the target charger or target vehicle respectively.

In another implementation in which the method 300 is executed directly by a computational device within the target charger, the system can identify a charging session based on a detected interaction with the target charger, such as a user interacting with an I/O device (e.g., a touchscreen and/or a button) of the charger or by detecting a plug-in event at the target charger. In this implementation, the system can direct the user to submit a vehicle ID or vehicle characteristics associated with the target vehicle.

In yet another implementation in which the method 300 is executed directly by a computational device within the target vehicle, the system can identify a charging session based on a detected interaction with an I/O device of the target vehicle or by detecting a plug-in event at a charging port of the target vehicle. In this implementation, the front-end module can direct the user to submit a charger ID (e.g., by copying a number displayed on the chargers or scanning a QR code) via the front-end application.

Upon detecting that a user has initiated a charging session, in some implementations, the system can initiate a charger stream with the target charger and/or retrieve or access charger characteristics of the target charger based on the charger ID. In instances in which a charger ID is not available, the system can access charger characteristics provided by the user via the front-end module. Additionally or alternatively, the system can automatically estimate charger characteristics based on data provided by the user, such as via text, audio, images, or video received from the front-end module.

Upon detecting that a user has initiated a charging session, in some implementations, the system can initiate a vehicle stream with the target vehicle and/or retrieve or access vehicle characteristics of the target vehicle based on the vehicle ID. In instances in which a vehicle ID is not available, the system can access vehicle characteristics provided by the user via the front-end module. Additionally or alternatively, the system can automatically estimate vehicle characteristics (e.g., the make, model, year, and trim of the vehicle) based on data provided by the user, such as via text, audio, images, or video received from the front-end module.

In one implementation, the system can initiate a charge session compliant with ISO 15118 to enable a handshake between the target charger and the target vehicle based on the charger ID of the target charger and the vehicle ID of the target vehicle.

Thus, the system can identify the target charger and/or the target vehicle upon initiation of a charging session. Additionally, the system can retrieve known characteristics associated with the charger ID of the target charger or the target vehicle and/or estimate other unknown characteristics based on user inputs and/or contextual information.

### 5. Generating a System Prompt

Generally, the system can generate a system prompt based on characteristics of the target charger and characteristics of the target vehicle to provide context to the LLM module, thereby enabling more specific responses to user inquiries and/or prompt conditions. More specifically, the system can retrieve: technical specifications and/or manuals for the target charger hardware and/or software version; technical specifications for the make, model, year, and/or trim of the target vehicle; and/or historical data on the charging behavior of chargers of the same type of the target charger and/or vehicles of the same make, model, year, and/or trim of the target vehicle. In some implementations, the system prompt can also include information about the charging site, such as safety concerns, local amenities, current or near-future weather conditions, current or near-future grid demand/conditions, or any other feature of the charging site that may be relevant to the user. In addition to information about the target charger and the target vehicle, the system prompt can include generalized troubleshooting information that may be relevant to electric vehicle charging and/or instructions for the LLM module to act as an assistant for the charging session between the target charger and the target vehicle. Thus, the system provides context to the LLM module enabling the LLM module to provide relevant guidance to the user during the charging session.

In one implementation, the system can represent, in the system prompt for the LLM module, a set of functions as well as a set of parameters associated with each function in the set of functions to prepare the LLM module to effectively utilize the set of functions. Thus, the system can provide the LLM module with any information relevant to calling the set of functions executable by the function module.

### 6. Monitoring the Charging Session and Generating Prompts

Generally, upon initiating the charger stream and/or the vehicle stream, the system can monitor the charger stream and/or the vehicle stream for the set of prompt conditions via the prompt generation module. More specifically, the system can evaluate a set of prompt conditions via an evaluation model or by directly identifying a prompt condition in the set of prompt conditions.

In one implementation, the system can detect the presence of specific status codes (e.g., error codes) indicating specific problems with the charger. In this implementation, the system can generate a prompt for the LLM module, including the specific code detected in the charger stream and/or the vehicle stream. In one example of this implementation, the system can include a subseries of status codes from the charger stream or the vehicle stream prior to an error code to provide additional context to the LLM module for the cause of the error.

In another implementation, the system can periodically classify the charging session as necessitating a prompt to the LLM module (i.e., a positive classification) or not necessitating a prompt to the LLM module (i.e., a negative classification) by executing the evaluation model on the charger stream and/or the vehicle stream. In an example of this implementation, the system can also utilize environmental data as input to the evaluation model. In response to detecting a positive classification, the system can generate a prompt for transmission to the LLM module, including a subseries of status codes from the charger stream and/or the vehicle stream.

In yet another implementation, the system can include text inputs from the user and prior responses from the LLM module as input to the evaluation model to utilize information provided by the user that may inform responses by the LLM module. For example, in this implementation, the system can detect error codes in the charger stream and inputs from the user indicating that the charging cable appears damaged to diagnose the charging issue and advise the user to use a different charger. In this implementation, the system can generate a prompt including user inputs from the front-end module in response to user inputs to the front-end module and a series of status codes from the charger stream and/or the vehicle stream. In one example of this implementation, the system can receive a user response via the front-end module and generate a prompt for the LLM module including the user response, thereby forwarding the user response to the LLM module.

Upon generating a prompt for transmission to the LLM module, the system can transmit the prompt to the LLM module and await a response from the LLM module.

### 7. LLM Response Handling

Generally, the system can receive a response from the LLM module and categorize the response as either a function call or a direct response to the user. In response to identifying the response as a function call, the system can extract relevant parameters from the function call, execute the called function via the function module, and transmit the function output back to the LLM module for inclusion in a direct response to the user. In response to identifying the response as a direct response to the user, the system can transmit the response to the front-end module for display to the user. Thus, the system can interface with the LLM module to call functions or transmit LLM responses to the front-end module for display to the user based on the content of the LLM response.

In one implementation, the system can execute a charge time estimation function as described in U.S. Provisional Patent Application No. 63/550,986 with parameters including the make, model, year, and/or trim of the vehicle, the type of charger, the current state of charge of the battery, the current temperature, and/or additional parameters described in U.S. Provisional Patent Application No. 63/550,986. Thus, the system can calculate a more accurate estimated charge time in response to a request by the user.

In another implementation, the system can execute a remote reset function with parameters indicating the type of reset to perform at the target charger. The system can then transmit a reset command to the target charger and attempt to reinitiate a charger stream upon completion of the reset.

In yet another implementation, the system can execute a charger operational function with parameters sufficient to specify an operational mode of the charger. In this implementation, the system can execute a charger operational function that changes the operational mode of the target charger or the set of chargers at the charging site of the target charger. For example, the system can execute a charger operational function that can modify the power output of the target charger or any chargers in the set of chargers at the charging site of the target charger to effectively load balance power delivered at the charging site. In another example, the system can execute a charger operational function to switch between various standard charging and fast charging modes. In yet another example, the system can execute a charger operational function to select a “green” charging mode that prioritizes the use of renewable electricity sources when available. In yet another example, the system can execute a charger operational function to select a reservation mode that reserves a charger for a specific user ahead of time. In yet another example, the system can execute a charger operational function to cancel or override idle fees accrued at the charger (e.g., in the event of a technical fault or other inconvenience to the user). Thus, the system can directly interface with the target charger and/or other chargers at the charging site to adjust the charging experience to a user's needs via execution of charger operational functions.

In yet another implementation, the system can execute a vehicle operational function that modifies certain vehicle-side parameters for the charging session. For example, the system can execute a vehicle operational function to modify a charging limit of the target vehicle. In another example, the system can modify a charging schedule of the target vehicle. Thus, the system can actively overcome common causes of charging issues on the vehicle side via direct modification of certain vehicle-side parameters. In some implementations, the system may transmit, to the target charger and/or to the target vehicle, a command to start or stop charging. For example, if a charging session faults mid-charge, a remote restart command may be issued to resume charging. Such control functions may be executed based on user input, contextual conditions, and/or LLM-generated recommendations.

In yet another implementation, the system can execute a work order submission function to log a work order to repair the target charger in response to a charging issue detected during the charging session. In this implementation, the system can execute the work order submission function with parameters including various error codes received during the charging session, a work order code representing the type of work relevant to fixing the charging issue, a list of part numbers for replacement parts relevant to fixing the charging issue, and/or image or video files depicting hardware damage to the target charger. Additionally or alternatively, the system can transmit any other recorded content from the charging status within the work order including vehicle status codes from the vehicle stream and text input from the user and/or LLM responses, which may further describe the technical problem experienced during the charging session. Thus, the system can enable charging network providers to reduce the downtime of broken chargers, thereby improving the reliability of the charging network and, as a result, improving the charging experience for users of the charging network.

In yet another implementation, the system can execute a charger availability function that queries the charging network provider to determine the real-time status of a set of chargers located at the same charging site as the target charger. In this implementation, the system can execute the charger availability function with a parameter including the target charger ID. Thus, the system can advise the user of other chargers that are available and functioning nearby, if the target charger is not functioning, thereby ensuring that the user is able to charge at the charging site. In some implementations, the system may further facilitate a seamless transition to another available charger by remotely initiating a reservation or default start sequence at the identified charger. For example, the system may detect that another charger at the site was recently used and is now available, and may automatically initiate a no-cost or discounted session to simplify the user experience and preserve the success of the visit.

In yet another implementation, the system can execute a charging cost function that estimates the cost of the charge at the target charger. In this implementation, the system can execute the charging cost function with parameters including the real-time grid electricity demand, the real-time grid supply composition, and/or the amount of energy to be delivered to the target vehicle. Thus, the system can respond accurately to a user requesting information about the cost of a charge and can deliver recommendations on when to charge at a lower cost.

In yet another implementation, the system can execute a carbon intensity function that estimates the amount of carbon or carbon dioxide released as a result of the charging session. In this implementation, the system can execute the carbon intensity function with parameters including the real-time grid supply composition and/or the amount of energy to be delivered to the target vehicle. Thus, the system can respond to user requests about the carbon footprint of his or her charging activity and can deliver recommendations on when to charge the target vehicle to minimize carbon emissions. In some implementations, the carbon intensity function may additionally or alternatively evaluate time-dependent price implications associated with energy sourcing. For example, the system may determine that during a 6:00 PM charging session in California, solar generation is ramping down while natural gas plants are coming online to meet increased demand. The system may inform the user that the current charge is subject to on-peak pricing and is projected to be sourced from a grid mix of approximately 50% solar and/or battery storage and 50% natural gas, thereby allowing the user to make informed decisions about charge timing based on both emissions and cost.

Additionally, the system can execute any other function related to managing a charging session via modifications to the operation of the target charger or target vehicle, updates or changes to the backend of the charging network operator of the target vehicle, precise estimates of charging duration, and/or retrieving of information that may be helpful for the user during the charging session (such as nearby amenities, available discounts, etc.).

The methods described herein can be embodied and/or implemented, at least in part, as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented, at least in part, as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer-readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

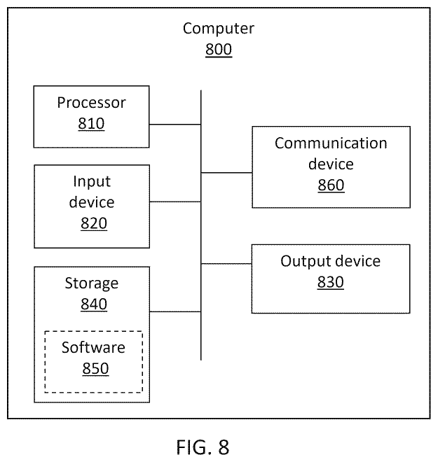

In one or more examples, the disclosed systems and methods utilize or may include a computer system. FIG. 8 depicts an exemplary computing system according to one or more examples of the disclosure. Computer 800 can be a host computer connected to a network. Computer 800 can be a client computer or a server. As shown in FIG. 8, computer 800 can be any suitable type of microprocessor-based device, such as a personal computer, workstation, server, or handheld computing device, such as a phone or tablet. The computer can include, for example, one or more of processor 810, input device 820, output device 830, storage 840, and communication device 860. Input device 820 and output device 830 can correspond to those described above and can either be connectable or integrated with the computer.

Input device 820 can be any suitable device that provides input, such as a touch screen or monitor, keyboard, mouse, or voice-recognition device. Output device 830 can be any suitable device that provides an output, such as a touch screen, monitor, printer, disk drive, or speaker.

Storage 840 can be any suitable device that provides storage, such as an electrical, magnetic, or optical memory, including a random-access memory (RAM), cache, hard drive, CD-ROM drive, tape drive, or removable storage disk. Communication device 860 can include any suitable device capable of transmitting and receiving signals over a network, such as a network interface chip or card. The components of the computer can be connected in any suitable manner, such as via a physical bus or wirelessly. Storage 840 can be a non-transitory computer-readable storage medium comprising one or more programs, which, when executed by one or more processors, such as processor 810, cause the one or more processors to execute methods described herein.

Software 850, which can be stored in storage 840 and executed by processor 810, can include, for example, the programming that embodies the functionality of the present disclosure (e.g., as embodied in the systems, computers, servers, and/or devices as described above). In one or more examples, software 850 can include a combination of servers such as application servers and database servers.

Software 850 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 840, that can contain or store programming for use by or in connection with an instruction execution system, apparatus, or device.

Software 850 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 800 can implement any operating system suitable for operating on the network. Software 850 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. As a person skilled in the art will recognize from the previous detailed description and from the figures and claims, modifications and changes can be made to the embodiments of the invention without departing from the scope of this invention as defined in the following claims. The embodiments were chosen and described in order to best explain the principles of the techniques and their practical applications. Others skilled in the art are thereby enabled to best utilize the techniques and various embodiments with various modifications as are suited to the particular use contemplated.

### Exemplary Embodiments

Exemplary embodiments of the method for facilitating a charging session between a target charger and target vehicle described herein include:

Embodiment 1. A method for facilitating a charging session between a target charger and target vehicle comprising:
receiving a charger ID of the target charger and a vehicle ID of the target vehicle;
based on the charger ID:
   accessing a hardware type and a software version of the target charger; and
   initiating a charger status stream with the target charger, the charger status stream comprising a series of charger statuses generated by the target charger;
based on the vehicle ID:
   accessing a make and a model of the target vehicle; and
   initiating a vehicle status stream with the target vehicle, the vehicle status stream comprising a series of vehicle statuses generated by the target vehicle;
generating a system prompt for an LLM based on:
   the hardware type of the target charger;
   the software version of the target charger;
   the make of the target vehicle; and
   the model of the target vehicle;
monitoring the charger status stream and the vehicle status stream for a set of prompt conditions; and
in response to detecting a prompt condition in the set of prompt conditions based on the charger status stream and the vehicle status stream, transmitting a prompt to the LLM comprising:
   the system prompt for the LLM;
   a subseries of charger statuses in the series of charger statuses; and
   a subseries of vehicle statuses in the series of vehicle statuses.

Embodiment 2. The method of embodiment 1, further comprising, in response to receiving an output from the LLM comprising a function call to the target charger, transmitting the function call to the target charger, the function call effective to modify operation of the target charger.

Embodiment 3. The method of embodiment 1 or 2, further comprising, in response to receiving an output from the LLM comprising a response addressed to a user of the target charger and the target vehicle, transmitting the response to the user via a front-end application.

Embodiment 4. The method of any one of embodiments 1-3, further comprising, in response to receiving an output from the LLM comprising a function call to the target vehicle, transmitting the function call to the target vehicle, the function call effective to modify operation of the target vehicle.

Embodiment 5. The method of any one of embodiments 1-4, further comprising, in response to receiving an output from the LLM comprising a function call to a charging network of the target charger, transmitting the function call to the charging network, the function call effective to report damage or a software issue affecting the target charger.

Embodiment 6. The method of any one of embodiments 1-5, wherein generating the system prompt for the LLM further comprises:
accessing a set of environmental data at the target charger, based on the charger ID, the set of environmental data comprising:
   a temperature at the target charger;
   a current time of day;
   a current day of the week;
   a current grid demand estimate; or
   a current grid composition estimate; and
generating the system prompt for an LLM based on:
   the hardware type of the target charger;
   the software version of the target charger;
   the make of the target vehicle;
   the model of the target vehicle; and
   the set of environmental data.

Embodiment 7. A method for charging a target vehicle using a target charger comprising:
receiving data, from the target charger or a user device executing a front-end module, indicating a status of the target vehicle or the target charger;
determining a hardware type of the target charger and a software version of the target charger;
generating a system prompt for an LLM based on:
   the hardware type of the target charger;
   the software version of the target charger; and
   the received data indicating the status of the target vehicle or the target charger;
in response to detecting a prompt condition based on the received data, transmitting a prompt to the LLM comprising:
   the system prompt for the LLM; and
   at least a portion of the received data;
receiving an output from the LLM; and
charging the target vehicle using the target charger in accordance with the output from the LLM or displaying an instruction to the user to charge the target vehicle using the target charger in accordance with the output from the LLM.

Embodiment 8. A system for charging a target vehicle using a target charger, the system comprising:
the target charger, wherein the target charger is configured to charge the target vehicle; and
a computing system comprising a memory and one or more processors, wherein the memory stores instructions that when executed by the one or more processors, cause the system to:
   determine a hardware type of the target charger and a software version of the target charger;
   receive data, from the target charger or a user device executing a front-end module, indicating a status of the target vehicle or the target charger;
   generate a system prompt for an LLM based on at least one parameter selected from a group consisting of: the hardware type of the target charger, the software version of the target charger, and the received data indicating the status of the target vehicle or the target charger;
   transmit the system prompt to the LLM;
   receive an output from the LLM; and
   charge the target vehicle using the target charger in accordance with the output from the LLM or display an instruction to a user to charge the target vehicle using the target charger in accordance with the output from the LLM.

Embodiment 9. The system of embodiment 8, wherein the system further comprises one or more cameras positioned in a vicinity of the target charger.

Embodiment 10. The system of embodiment 9, wherein the instructions further cause the system to obtain, from the one or more cameras positioned in the vicinity of the target charger, visual data corresponding to a physical environment of the target charger.

Embodiment 11. The system of embodiment 10, wherein the instructions further cause the system to identify, based on the visual data, one or more features associated with a charging session, wherein the one or more features are selected from a group consisting of: the target vehicle, the target charger, and the user.

Embodiment 12. The system of embodiment 11, wherein generating the system prompt for the LLM is further based on the one or more features associated with the charging session;

Embodiment 13. A system for charging a target vehicle using a target charger, the system comprising:
the target charger, wherein the target charger is configured to charge the target vehicle;
one or more cameras positioned in a vicinity of the target charger; and
a computing system comprising a memory and one or more processors, wherein the memory stores instructions that when executed by the one or more processors, cause the system to:
   determine a hardware type of the target charger and a software version of the target charger;
   obtain, from the one or more cameras positioned in the vicinity of the target charger, visual data corresponding to a physical environment of the target charger;
   identify, based on the visual data, one or more features associated with a charging session, wherein the one or more features are selected from a group consisting of: the target vehicle, the target charger, and a user;
   generate a system prompt for a large language model (LLM) based on at least one parameter selected from a group consisting of: the hardware type of the target charger, the software version of the target charger, and the one or more features associated with the charging session;
   transmit the system prompt to the LLM;
   receive an output from the LLM; and
   charge the target vehicle using the target charger in accordance with the output from the LLM or display an instruction to the user to charge the target vehicle using the target charger in accordance with the output from the LLM.

Embodiment 14. The system of embodiment 13, wherein both the hardware type of the target charger and the software version of the target charger are determined based on a geographic location of a user device or a geographic location of the target vehicle.

Embodiment 15. The system of embodiment 13 or 14, wherein both the hardware type of the target charger and the software version of the target charger are based on information provided by the user or on information transmitted from the target charger.

Embodiment 16. The system of any one of embodiments 13-15, wherein the system prompt is generated based at least in part on historical fault data or usage patterns associated with the target charger.

Embodiment 17. The system of any one of embodiments 13-16, wherein the instructions further cause the system to receive vehicle status data from the target vehicle, the vehicle status data comprising one or more vehicle statuses associated with the charging session.

Embodiment 18. The system of embodiment 17, wherein the instructions further cause the system to determine, based on information provided by the user or on information transmitted from the target charger, a make of the target vehicle and a model of the target vehicle.

Embodiment 19. The system of embodiment 18, wherein generating the system prompt for the LLM is further based on at least one parameter selected from a group consisting of: the make of the target vehicle, the model of the target vehicle, and at least one of the one or more vehicle statuses.

Embodiment 20. The system of any one of embodiments 13-19, wherein the instructions further cause the system to receive charger status data from the target charger, the charger status data comprising one or more charger statuses associated with the charging session, wherein generating the system prompt for the LLM is further based on at least one of the one or more charger statuses.

Embodiment 21. The system of any one of embodiments 13-20, wherein the visual data comprises video data.

Embodiment 22. The system of any one of embodiments 13-21, wherein the visual data comprises one or more images.

Embodiment 23. The system of any one of embodiments 13-22, wherein the visual data is further obtained from a device of the user comprising a camera.

Embodiment 24. The system of any one of embodiments 13-23, wherein the one or more features associated with the charging session comprise the target vehicle, the target charger, and the user.

Embodiment 25. The system of any one of embodiments 13-24, wherein the one or more features associated with the charging session comprise a user interaction with the target charger.

Embodiment 26. The system of embodiment 25, wherein the user interaction comprises physically connecting or disconnecting a charging cable from the target charger.

Embodiment 27. The system of embodiment 25, wherein the user interaction comprises engaging with a user interface element of the target charger, wherein the user interface element comprises a touchscreen, button, or card reader.

Embodiment 28. The system of any one of embodiments 13-27, wherein the one or more features associated with the charging session comprise at least one attribute of the target vehicle selected from a group consisting of: a make, a model, and a year of manufacture.

Embodiment 29. The system of any one of embodiments 13-28, wherein the one or more features associated with the charging session comprise alphanumeric content corresponding to a display of the target charger or a license plate of the target vehicle.

Embodiment 30. The system of any one of embodiments 13-29, wherein the LLM is a multimodal model configured to process visual and textual inputs, and wherein the system prompt comprises at least a portion of the visual data.

Embodiment 31. The system of any one of embodiments 13-30, wherein generating the system prompt for the LLM is further based on at least one environmental data parameter associated with the target charger, selected from a group consisting of: a temperature at the target charger, a current time of day, a current day of the week, a current grid demand estimate, and a current grid composition estimate.

Embodiment 32. The system of any one of embodiments 13-31, wherein generating the system prompt for the LLM is based on a user query received from a front-end module installed on a device of the user.

Embodiment 33. The system of any one of embodiments 13-32, wherein charging the target vehicle using the target charger in accordance with the output from the LLM comprises at least one action selected from a group consisting of: transmitting a control command to reset the target charger, modifying a power delivery setting of the target charger, initiating a diagnostic operation on the target charger, and reporting a fault condition of the target charger.

Embodiment 34. The system of any one of embodiments 13-33, wherein displaying an instruction to the user to charge the target vehicle comprises displaying the instruction to the user on a device of the user or a display of the target charger.

Embodiment 35. The system of any one of embodiments 13-34, wherein displaying the instruction to the user comprises:
generating an indication corresponding to a component of the target charger or a component of the target vehicle; and
instructing the user to perform a physical action with respect to the component of the target charger or the component of the target vehicle.

Embodiment 36. The system of embodiment 35, wherein the indication is based on the one or more features identified based on the visual data corresponding to the physical environment of the target charger.

Embodiment 37. The system of any one of embodiments 13-36, wherein displaying the instruction to the user comprises displaying a sequence of steps configured to guide the user in resolving a charging-related issue.

Embodiment 38. The system of embodiment 37, wherein the instructions further cause the system to monitor, based on the visual data, user activity indicative of progress toward completing one or more of the sequence of steps.

Embodiment 39. The system of embodiment 38, wherein displaying a step of the sequence of steps is based on a determination that the user completed a prior step of the sequence of steps.

Embodiment 40. The system of any one of embodiments 13-39, wherein the instructions further cause the system to display, in response to receiving the output from the LLM, one or more affordances on a user interface, the one or more affordances corresponding to transmitting a communication to the user or transmitting a command to modify an operational state of the target charger.

Embodiment 41. The system of embodiment 40, wherein the command to modify the operational state of the target charger corresponds to at least one action selected from a group consisting of: resetting the target charger, modifying a power delivery setting of the target charger, and initiating a diagnostic operation on the target charger.

Embodiment 42. The system of embodiment 40, wherein the instructions further cause the system to display on the user interface the visual data corresponding to the physical environment of the target charger.

Embodiment 43. The system of embodiment 40, wherein the instructions further cause the system to display on the user interface information associated with a prior charging session associated with the target charger or the user.

Embodiment 44. The system of any one of embodiments 13-43, wherein the instructions further cause the system to:
monitor the visual data corresponding to the physical environment of the target charger;
detect an event associated with the target charger; and
in response to detecting the event, display a notification on a user interface.

Embodiment 45. The system of embodiment 44, wherein the event is indicative of abnormal use of the target charger or a fault condition of the target charger.

Embodiment 46. The system of any one of embodiments 13-45, wherein the instructions further cause the system to, in response to receiving an output from the LLM comprising a function call to the target charger, transmit the function call to the target charger, the function call effective to modify operation of the target charger.

Embodiment 47. The system of any one of embodiments 13-46, wherein the instructions further cause the system to, in response to receiving an output from the LLM comprising a function call to the target vehicle, transmit the function call to the target vehicle, the function call effective to modify operation of the target vehicle.

Embodiment 48. The system of any one of embodiments 13-47, wherein the instructions further cause the system to, in response to receiving an output from the LLM comprising a function call to a charging network of the target charger, transmit the function call to the charging network, the function call effective to report damage to the target charger, a software issue affecting the target charger, or both.

Embodiment 49. The system of any one of embodiments 13-48, wherein the instructions further cause the system to, in response to receiving an output from the LLM comprising a function call to a user device, transmit the function call to the user device, the function call effective to activate a camera on the user device and prompt the user to capture visual data depicting the target vehicle or the target charger.

Embodiment 50. A method for charging a target vehicle using a target charger, the method comprising:
determining a hardware type of the target charger and a software version of the target charger;
obtaining, from one or more cameras positioned in a vicinity of the target charger, visual data corresponding to a physical environment of the target charger;
identifying, based on the visual data, one or more features associated with a charging session, wherein the one or more features are selected from a group consisting of: the target vehicle, the target charger, and a user;
generating a system prompt for a large language model (LLM) based on at least one parameter selected from a group consisting of: the hardware type of the target charger, the software version of the target charger, and the one or more features associated with the charging session;
transmitting the system prompt to the LLM;
receiving an output from the LLM; and
charging the target vehicle using the target charger in accordance with the output from the LLM or displaying an instruction to the user to charge the target vehicle using the target charger in accordance with the output from the LLM.

Embodiment 51. The method of embodiment 50, wherein determining both the hardware type of the target charger and the software version of the target charger is based on a geographic location of a user device or a geographic location of the target vehicle.

Embodiment 52. The method of embodiment 50 or 51, wherein determining both the hardware type of the target charger and the software version of the target charger is based on information provided by the user or on information transmitted from the target charger.

Embodiment 53. The method of any one of embodiments 50-52, wherein generating the system prompt is based at least in part on historical fault data or usage patterns associated with the target charger.

Embodiment 54. The method of any one of embodiments 50-53, further comprising receiving vehicle status data from the target vehicle, the vehicle status data comprising one or more vehicle statuses associated with the charging session.

Embodiment 55. The method of embodiment 54, further comprising determining, based on information provided by the user or on information transmitted from the target charger, a make of the target vehicle and a model of the target vehicle.

Embodiment 56. The method of embodiment 55, wherein generating the system prompt is further based on at least one parameter selected from a group consisting of: the make of the target vehicle, the model of the target vehicle, and at least one of the one or more vehicle statuses.

Embodiment 57. The method of any one of embodiments 50-56, further comprising receiving charger status data from the target charger, the charger status data comprising one or more charger statuses associated with the charging session, wherein generating the system prompt is further based on at least one of the one or more charger statuses.

Embodiment 58. The method of any one of embodiments 50-57, wherein the visual data comprises video data.

Embodiment 59. The method of any one of embodiments 50-58, wherein the visual data comprises one or more images.

Embodiment 60. The method of any one of embodiments 50-59, wherein the visual data is further obtained from a device of the user comprising a camera.

Embodiment 61. The method of any one of embodiments 50-60, wherein the one or more features associated with the charging session comprise the target vehicle, the target charger, and the user.

Embodiment 62. The method of any one of embodiments 50-61, wherein the one or more features associated with the charging session comprise a user interaction with the target charger.

Embodiment 63. The method of embodiment 62, wherein the user interaction comprises physically connecting or disconnecting a charging cable from the target charger.

Embodiment 64. The method of embodiment 62, wherein the user interaction comprises engaging with a user interface element of the target charger, wherein the user interface element comprises a touchscreen, button, or card reader.

Embodiment 65. The method of any one of embodiments 50-64, wherein the one or more features associated with the charging session comprise at least one attribute of the target vehicle selected from a group consisting of: a make, a model, and a year of manufacture.

Embodiment 66. The method of any one of embodiments 50-65, wherein the one or more features associated with the charging session comprise alphanumeric content corresponding to a display of the target charger or a license plate of the target vehicle.

Embodiment 67. The method of any one of embodiments 50-66, wherein the LLM is a multimodal model configured to process visual and textual inputs, and wherein the system prompt comprises at least a portion of the visual data.

Embodiment 68. The method of any one of embodiments 50-67, wherein generating the system prompt is further based on at least one environmental data parameter associated with the target charger, selected from a group consisting of: a temperature at the target charger, a current time of day, a current day of the week, a current grid demand estimate, and a current grid composition estimate.

Embodiment 69. The method of any one of embodiments 50-68, wherein generating the system prompt is based on a user query received from a front-end module installed on a device of the user.

Embodiment 70. The method of any one of embodiments 50-69, wherein charging the target vehicle using the target charger in accordance with the output from the LLM comprises at least one action selected from a group consisting of: transmitting a control command to reset the target charger, modifying a power delivery setting of the target charger, initiating a diagnostic operation on the target charger, and reporting a fault condition of the target charger.

Embodiment 71. The method of any one of embodiments 50-70, wherein displaying an instruction to the user to charge the target vehicle comprises displaying the instruction to the user on a device of the user or a display of the target charger.

Embodiment 72. The method of any one of embodiments 50-71, wherein displaying the instruction to the user comprises:
generating an indication corresponding to a component of the target charger or a component of the target vehicle; and
instructing the user to perform a physical action with respect to the component of the target charger or the component of the target vehicle.

Embodiment 73. The method of embodiment 72, wherein the indication is based on the one or more features identified based on the visual data corresponding to the physical environment of the target charger.

Embodiment 74. The method of any one of embodiments 50-73, wherein

displaying the instruction to the user comprises displaying a sequence of steps configured to guide the user in resolving a charging-related issue.

Embodiment 75. The method of embodiment 74, further comprising monitoring, based on the visual data, user activity indicative of progress toward completing one or more of the sequence of steps.

Embodiment 76. The method of embodiment 75, wherein displaying a step of the sequence of steps is based on a determination that the user completed a prior step of the sequence of steps.

Embodiment 77. The method of any one of embodiments 50-76, further comprising displaying, in response to receiving the output from the LLM, one or more affordances on a user interface, the one or more affordances corresponding to transmitting a communication to the user or transmitting a command to modify an operational state of the target charger.

Embodiment 78. The method of embodiment 77, wherein the command to modify the operational state of the target charger corresponds to at least one action selected from a group consisting of: resetting the target charger, modifying a power delivery setting of the target charger, and initiating a diagnostic operation on the target charger.

Embodiment 79. The method of embodiment 77, further comprising displaying on the user interface the visual data corresponding to the physical environment of the target charger.

Embodiment 80. The method of embodiment 77, further comprising displaying on the user interface information associated with a prior charging session associated with the target charger or the user.

Embodiment 81. The method of any one of embodiments 50-80, further comprising:
monitoring the visual data corresponding to the physical environment of the target charger;
detecting an event associated with the target charger; and
in response to detecting the event, displaying a notification on a user interface.

Embodiment 82. The method of embodiment 81, wherein the event is indicative of abnormal use of the target charger or a fault condition of the target charger.

Embodiment 83. The method of any one of embodiments 50-82, further comprising, in response to receiving an output from the LLM comprising a function call to the target charger, transmitting the function call to the target charger, the function call effective to modify operation of the target charger.

Embodiment 84. The method of any one of embodiments 50-83, further comprising, in response to receiving an output from the LLM comprising a function call to the target vehicle, transmitting the function call to the target vehicle, the function call effective to modify operation of the target vehicle.

Embodiment 85. The method of any one of embodiments 50-84, further comprising, in response to receiving an output from the LLM comprising a function call to a charging network of the target charger, transmitting the function call to the charging network, the function call effective to report damage to the target charger, a software issue affecting the target charger, or both.

Embodiment 86. The method of any one of embodiments 50-85, further comprising, in response to receiving an output from the LLM comprising a function call to a user device, transmitting the function call to the user device, the function call effective to activate a camera on the user device and prompt the user to capture visual data depicting the target vehicle or the target charger.

Embodiment 87. A non-transitory computer readable storage medium storing instructions for charging a target vehicle using a target charger, wherein the instructions, when executed by one or more processors of an electronic device, cause the device to:
determine a hardware type of the target charger and a software version of the target charger;
obtain, from the one or more cameras positioned in the vicinity of the target charger, visual data corresponding to a physical environment of the target charger;
identify, based on the visual data, one or more features associated with a charging session, wherein the one or more features are selected from a group consisting of: the target vehicle, the target charger, and a user;
generate a system prompt for a large language model (LLM) based on at least one parameter selected from a group consisting of: the hardware type of the target charger, the software version of the target charger, and the one or more features associated with the charging session;
transmit the system prompt to the LLM;
receive an output from the LLM; and
charge the target vehicle using the target charger in accordance with the output from the LLM or display an instruction to the user to charge the target vehicle using the target charger in accordance using the target charger with the output from the LLM.

Embodiment 88. The non-transitory computer readable storage medium of embodiment 87, wherein both the hardware type of the target charger and the software version of the target charger are determined based on a geographic location of a user device or a geographic location of the target vehicle.

Embodiment 89. The non-transitory computer readable storage medium of embodiment 87 or 88, wherein both the hardware type of the target charger and the software version of the target charger are based on information provided by the user or on information transmitted from the target charger.

Embodiment 90. The non-transitory computer readable storage medium of any one of embodiments 87-89, wherein the system prompt is generated based at least in part on historical fault data or usage patterns associated with the target charger.

Embodiment 91. The non-transitory computer readable storage medium of any one of embodiments 87-90, wherein the instructions further cause the system to receive vehicle status data from the target vehicle, the vehicle status data comprising one or more vehicle statuses associated with the charging session.

Embodiment 92. The non-transitory computer readable storage medium of embodiment 91, wherein the instructions further cause the system to determine, based on information provided by the user or on information transmitted from the target charger, a make of the target vehicle and a model of the target vehicle.

Embodiment 93. The non-transitory computer readable storage medium of embodiment 92, wherein generating the system prompt for the LLM is further based on at least one parameter selected from a group consisting of: the make of the target vehicle, the model of the target vehicle, and at least one of the one or more vehicle statuses.

Embodiment 94. The non-transitory computer readable storage medium of any one of embodiments 87-93, wherein the instructions further cause the system to receive charger status data from the target charger, the charger status data comprising one or more charger statuses associated with the charging session, wherein generating the system prompt for the LLM is further based on at least one of the one or more charger statuses.

Embodiment 95. The non-transitory computer readable storage medium of any one of embodiments 87-94, wherein the visual data comprises video data.

Embodiment 96. The non-transitory computer readable storage medium of any one of embodiments 87-95, wherein the visual data comprises one or more images.

Embodiment 97. The non-transitory computer readable storage medium of any one of embodiments 87-96, wherein the visual data is further obtained from a device of the user comprising a camera.

Embodiment 98. The non-transitory computer readable storage medium of any one of embodiments 87-97, wherein the one or more features associated with the charging session comprise the target vehicle, the target charger, and the user.

Embodiment 99. The non-transitory computer readable storage medium of any one of embodiments 87-98, wherein the one or more features associated with the charging session comprise a user interaction with the target charger.

Embodiment 100. The non-transitory computer readable storage medium of embodiment 99, wherein the user interaction comprises physically connecting or disconnecting a charging cable from the target charger.

Embodiment 101. The non-transitory computer readable storage medium of embodiment 99, wherein the user interaction comprises engaging with a user interface element of the target charger, wherein the user interface element comprises a touchscreen, button, or card reader.

Embodiment 102. The non-transitory computer readable storage medium of any one of embodiments 87-101, wherein the one or more features associated with the charging session comprise at least one attribute of the target vehicle selected from a group consisting of: a make, a model, and a year of manufacture.

Embodiment 103. The non-transitory computer readable storage medium of any one of embodiments 87-102, wherein the one or more features associated with the charging session comprise alphanumeric content corresponding to a display of the target charger or a license plate of the target vehicle.

Embodiment 104. The non-transitory computer readable storage medium of any one of embodiments 87-103, wherein the LLM is a multimodal model configured to process visual and textual inputs, and wherein the system prompt comprises at least a portion of the visual data.

Embodiment 105. The non-transitory computer readable storage medium of any one of embodiments 87-104, wherein generating the system prompt for the LLM is further based on at least one environmental data parameter associated with the target charger, selected from a group consisting of: a temperature at the target charger, a current time of day, a current day of the week, a current grid demand estimate, and a current grid composition estimate.

Embodiment 106. The non-transitory computer readable storage medium of any one of embodiments 87-105, wherein generating the system prompt for the LLM is based on a user query received from a front-end module installed on a device of the user.

Embodiment 107. The non-transitory computer readable storage medium of any one of embodiments 87-106, wherein charging the target vehicle using the target charger in accordance with the output from the LLM comprises at least one action selected from a group consisting of: transmitting a control command to reset the target charger, modifying a power delivery setting of the target charger, initiating a diagnostic operation on the target charger, and reporting a fault condition of the target charger.

Embodiment 108. The non-transitory computer readable storage medium of any one of embodiments 87-107, wherein displaying an instruction to the user to charge the target vehicle comprises displaying the instruction to the user on a device of the user or a display of the target charger.

Embodiment 109. The non-transitory computer readable storage medium of any one of embodiments 87-108, wherein displaying the instruction to the user comprises:
generating an indication corresponding to a component of the target charger or a component of the target vehicle; and
instructing the user to perform a physical action with respect to the component of the target charger or the component of the target vehicle.

Embodiment 110. The non-transitory computer readable storage medium of embodiment 109, wherein the indication is based on the one or more features identified based on the visual data corresponding to the physical environment of the target charger.

Embodiment 111. The non-transitory computer readable storage medium of any one of embodiments 87-110, wherein displaying the instruction to the user comprises displaying a sequence of steps configured to guide the user in resolving a charging-related issue.

Embodiment 112. The non-transitory computer readable storage medium of embodiment 111, wherein the instructions further cause the system to monitor, based on the visual data, user activity indicative of progress toward completing one or more of the sequence of steps.

Embodiment 113. The non-transitory computer readable storage medium of embodiment 112, wherein displaying a step of the sequence of steps is based on a determination that the user completed a prior step of the sequence of steps.

Embodiment 114. The non-transitory computer readable storage medium of any one of embodiments 87-113, wherein the instructions further cause the system to display, in response to receiving the output from the LLM, one or more affordances on a user interface, the one or more affordances corresponding to transmitting a communication to the user or transmitting a command to modify an operational state of the target charger.

Embodiment 115. The non-transitory computer readable storage medium of embodiment 114, wherein the command to modify the operational state of the target charger corresponds to at least one action selected from a group consisting of: resetting the target charger, modifying a power delivery setting of the target charger, and initiating a diagnostic operation on the target charger.

Embodiment 116. The non-transitory computer readable storage medium of embodiment 115, wherein the instructions further cause the system to display on the user interface the visual data corresponding to the physical environment of the target charger.

Embodiment 117. The non-transitory computer readable storage medium of embodiment 116, wherein the instructions further cause the system to display on the user interface information associated with a prior charging session associated with the target charger or the user.

Embodiment 118. The non-transitory computer readable storage medium of any one of embodiments 87-117, wherein the instructions further cause the system to:
monitor the visual data corresponding to the physical environment of the target charger;
detect an event associated with the target charger; and
in response to detecting the event, display a notification on a user interface.

Embodiment 119. The non-transitory computer readable storage medium of embodiment 118, wherein the event is indicative of abnormal use of the target charger or a fault condition of the target charger.

Embodiment 120. The non-transitory computer readable storage medium of any one of embodiments 87-119, wherein the instructions further cause the system to, in response to receiving an output from the LLM comprising a function call to the target charger, transmit the function call to the target charger, the function call effective to modify operation of the target charger.

Embodiment 121. The non-transitory computer readable storage medium of any one of embodiments 87-120, wherein the instructions further cause the system to, in response to receiving an output from the LLM comprising a function call to the target vehicle, transmit the function call to the target vehicle, the function call effective to modify operation of the target vehicle.

Embodiment 122. The non-transitory computer readable storage medium of any one of embodiments 87-121, wherein the instructions further cause the system to, in response to receiving an output from the LLM comprising a function call to a charging network of the target charger, transmit the function call to the charging network, the function call effective to report damage to the target charger, a software issue affecting the target charger, or both.

Embodiment 123. The non-transitory computer readable storage medium of any one of embodiments 87-122, wherein the instructions further cause the system to, in response to receiving an output from the LLM comprising a function call to a user device, transmit the function call to the user device, the function call effective to activate a camera on the user device and prompt the user to capture visual data depicting the target vehicle or the target charger.

1. A system for charging a target vehicle using a target charger, the system comprising:
the target charger, wherein the target charger is configured to charge the target vehicle;
one or more cameras positioned in a vicinity of the target charger; and
a computing system comprising a memory and one or more processors, wherein the memory stores instructions that when executed by the one or more processors, cause the system to:
determine a hardware type of the target charger and a software version of the target charger;
obtain, from the one or more cameras positioned in the vicinity of the target charger, visual data corresponding to a physical environment of the target charger;
identify, based on the visual data, one or more features associated with a charging session, wherein the one or more features are selected from a group consisting of: the target vehicle, the target charger, and a user;
generate a system prompt for a large language model (LLM) based on at least one parameter selected from a group consisting of: the hardware type of the target charger, the software version of the target charger, and the one or more features associated with the charging session;
transmit the system prompt to the LLM;
receive an output from the LLM; and
charge the target vehicle using the target charger in accordance with the output from the LLM or display an instruction to the user to charge the target vehicle using the target charger in accordance with the output from the LLM.

2. The system of claim 1, wherein both the hardware type of the target charger and the software version of the target charger are determined based on a geographic location of a user device or a geographic location of the target vehicle.

3. The system of claim 1, wherein both the hardware type of the target charger and the software version of the target charger are based on information provided by the user or on information transmitted from the target charger.

4. The system of claim 1, wherein the system prompt is generated based at least in part on historical fault data or usage patterns associated with the target charger.

5. The system of claim 1, wherein the instructions further cause the system to receive vehicle status data from the target vehicle, the vehicle status data comprising one or more vehicle statuses associated with the charging session.

6. The system of claim 5, wherein the instructions further cause the system to determine, based on information provided by the user or on information transmitted from the target charger, a make of the target vehicle and a model of the target vehicle.

7. The system of claim 6, wherein generating the system prompt for the LLM is further based on at least one parameter selected from a group consisting of: the make of the target vehicle, the model of the target vehicle, and at least one of the one or more vehicle statuses.

8. The system of claim 1, wherein the instructions further cause the system to receive charger status data from the target charger, the charger status data comprising one or more charger statuses associated with the charging session, wherein generating the system prompt for the LLM is further based on at least one of the one or more charger statuses.

9. The system of claim 1, wherein the visual data is further obtained from a device of the user comprising a camera.

10. The system of claim 1, wherein the one or more features associated with the charging session comprise the target vehicle, the target charger, and the user.

11. The system of claim 1, wherein the one or more features associated with the charging session comprise a user interaction with the target charger.

12. The system of claim 1, wherein the one or more features associated with the charging session comprise at least one attribute of the target vehicle selected from a group consisting of: a make, a model, and a year of manufacture.

13. The system of claim 1, wherein the one or more features associated with the charging session comprise alphanumeric content corresponding to a display of the target charger or a license plate of the target vehicle.

14. The system of claim 1, wherein the LLM is a multimodal model configured to process visual and textual inputs, and wherein the system prompt comprises at least a portion of the visual data.

15. The system of claim 1, wherein generating the system prompt for the LLM is based on a user query received from a front-end module installed on a device of the user.

16. The system of claim 1, wherein charging the target vehicle using the target charger in accordance with the output from the LLM comprises at least one action selected from a group consisting of: transmitting a control command to reset the target charger, modifying a power delivery setting of the target charger, initiating a diagnostic operation on the target charger, and reporting a fault condition of the target charger.

17. The system of claim 1, wherein displaying an instruction to the user to charge the target vehicle comprises displaying the instruction to the user on a device of the user or a display of the target charger.

18. The system of claim 1, wherein displaying the instruction to the user comprises:
generating an indication corresponding to a component of the target charger or a component of the target vehicle; and
instructing the user to perform a physical action with respect to the component of the target charger or the component of the target vehicle.

19. The system of claim 18, wherein the indication is based on the one or more features identified based on the visual data corresponding to the physical environment of the target charger.

20. The system of claim 1, wherein displaying the instruction to the user comprises displaying a sequence of steps configured to guide the user in resolving a charging-related issue.

21. The system of claim 20, wherein the instructions further cause the system to monitor, based on the visual data, user activity indicative of progress toward completing one or more of the sequence of steps.

22. The system of claim 21, wherein displaying a step of the sequence of steps is based on a determination that the user completed a prior step of the sequence of steps.

23. The system of claim 1, wherein the instructions further cause the system to display, in response to receiving the output from the LLM, one or more affordances on a user interface, the one or more affordances corresponding to transmitting a communication to the user or transmitting a command to modify an operational state of the target charger.

24. The system of claim 1, wherein the instructions further cause the system to:
monitor the visual data corresponding to the physical environment of the target charger;
detect an event associated with the target charger; and
in response to detecting the event, display a notification on a user interface.

25. The system of claim 24, wherein the event is indicative of abnormal use of the target charger or a fault condition of the target charger.

26. The system of claim 1, wherein the instructions further cause the system to, in response to receiving an output from the LLM comprising a function call to the target charger, transmit the function call to the target charger, the function call effective to modify operation of the target charger.

27. The system of claim 1, wherein the instructions further cause the system to, in response to receiving an output from the LLM comprising a function call to a charging network of the target charger, transmit the function call to the charging network, the function call effective to report damage to the target charger, a software issue affecting the target charger, or both.

28. The system of claim 1, wherein the instructions further cause the system to, in response to receiving an output from the LLM comprising a function call to a user device, transmit the function call to the user device, the function call effective to activate a camera on the user device and prompt the user to capture visual data depicting the target vehicle or the target charger.

29. A method for charging a target vehicle using a target charger, the method comprising:
determining a hardware type of the target charger and a software version of the target charger;
obtaining, from one or more cameras positioned in a vicinity of the target charger, visual data corresponding to a physical environment of the target charger;
identifying, based on the visual data, one or more features associated with a charging session, wherein the one or more features are selected from a group consisting of: the target vehicle, the target charger, and a user;
generating a system prompt for a large language model (LLM) based on at least one parameter selected from a group consisting of: the hardware type of the target charger, the software version of the target charger, and the one or more features associated with the charging session;
transmitting the system prompt to the LLM;
receiving an output from the LLM; and
charging the target vehicle using the target charger in accordance with the output from the LLM or displaying an instruction to the user to charge the target vehicle using the target charger in accordance with the output from the LLM.

30. A non-transitory computer readable storage medium storing instructions for charging a target vehicle using a target charger, wherein the instructions, when executed by one or more processors of an electronic device, cause the device to:
determine a hardware type of the target charger and a software version of the target charger;
obtain, from the one or more cameras positioned in the vicinity of the target charger, visual data corresponding to a physical environment of the target charger;
identify, based on the visual data, one or more features associated with a charging session, wherein the one or more features are selected from a group consisting of: the target vehicle, the target charger, and a user;
generate a system prompt for a large language model (LLM) based on at least one parameter selected from a group consisting of: the hardware type of the target charger, the software version of the target charger, and the one or more features associated with the charging session;
transmit the system prompt to the LLM;
receive an output from the LLM; and
charge the target vehicle using the target charger in accordance with the output from the LLM or display an instruction to the user to charge the target vehicle using the target charger in accordance with the output from the LLM.
